(19) United States
(12) Patent Application Publication
(10) Pub. No.: US 2026/0239324 A1
(43) Pub. Date: Aug. 13, 2026

(54) METHOD AND ELECTRONIC DEVICE FOR MANAGING TRAFFIC ON A COMMUNICATION CHANNEL FOR USER EQUIPMENT

(71) Applicant: Samsung Electronics Co., Ltd., Suwon-si (KR)

(72) Inventors: Kovvuri Jayendra REDDY, Bangalore (IN); Madhan Raj KANAGARATHINAM, Bangalore (IN); Shubham MITTAL, Bangalore (IN)

(21) Appl. No.: 19/646,053

(22) Filed: Apr. 13, 2026

Related U.S. Application Data
(63) Continuation of application No. PCT/KR2024/015356, filed on Oct. 11, 2024.

(30) Foreign Application Priority Data
Oct. 12, 2023 (IN) 202341068724
Sep. 20, 2024 (IN) 2023 41068724

(51) Int. Cl. H04W 72/0457; H04B 17/318; H04W 24/08

(52) U.S. Cl. CPC H04W 72/0457; H04B 17/318; H04W 24/08

(57) ABSTRACT

A method of an electronic device for managing traffic on a communication channel for a user equipment (UE) is provided. The method includes identifying real-time (RT) traffic and non-real-time (NRT) traffic associated with a plurality of applications on the UE, obtaining one or more network parameters and an end-to-end (EtE) bandwidth of the communication channel based on at least one of a historical EtE bandwidth estimate of the communication channel, the RT traffic, and the NRT traffic, predicting a bandwidth allocation for the NRT traffic and a bandwidth allocation for the RT traffic based on the obtained EtE bandwidth of the communication channel and the obtained one or more network parameters, and allocating an NRT bandwidth to the NRT traffic, and an RT bandwidth to the RT traffic based on the predicted bandwidth allocation for the NRT traffic and the predicted bandwidth allocation for the RT traffic.

### CROSS-REFERENCE TO RELATED APPLICATION(S)

This application is a continuation application, claiming priority under 35 U.S.C. § 365 (c), of an International application No. PCT/KR2024/015356, filed on Oct. 11, 2024, which is based on and claims the benefit of an Indian Provisional patent application number 202341068724, filed on Oct. 12, 2023, in the Indian Intellectual Property Office, and of an Indian Complete patent application No. 202341068724 filed on Sep. 20, 2024, in the Indian Intellectual Property Office, the disclosure of each of which is incorporated by reference herein in its entirety.

### BACKGROUND

### 1. Field

The disclosure relates to the field of telecommunications. More particularly, the disclosure relates to a system and method for managing traffic on a communication channel for a user equipment (UE).

### 2. Description of Related Art

Real-time applications require immediate or near-immediate data transmission to function effectively. Non-real-time applications are less time-sensitive and can tolerate delays in data transmission without significantly affecting user experience. In the context of real-time applications, and non-real-time applications, managing traffic on communication channels presents a challenge when real-time (RT) traffic, such as voice calls, video conferencing, online gaming, and live streaming competes with non-real-time (NRT) traffic, like background downloads, data synchronization, and social media updates. NRT traffic often competes for bandwidth with RT traffic, leading to increased latency, jitter, and a poor user experience.

Traditional traffic management solutions, such as differentiated services code point (DSCP) marking are not always effective, as the markings from the server may be removed by the intermediate routers. Other prioritization mechanisms (e.g., stream classification service (SCS) and mirrored stream classification service (MSCS)), are not widely supported or implemented across networks and routers.

Additionally, current methods for estimating end-to-end (EtE) bandwidth between user equipment (UE) and a server or destination on an Internet, is often measured using intrusive methods, such as speed tests that generate extra traffic and potentially interfere with ongoing applications. The mobility of user equipment (UE) adds further complexity, as bandwidth fluctuates with proximity to an access point (AP), making recalibration cycles for bandwidth estimation suboptimal and reactive rather than proactive. These challenges call for more efficient and less intrusive methods of bandwidth estimation that can adapt to dynamic network conditions and provide real-time optimizations.

Wireless fidelity (Wi-Fi) and fifth-generation (5G) in the UE have profoundly transformed gaming landscape in the UE. With increasingly powerful hardware, high-resolution displays, and ever-expanding application ecosystems, the UE has become a primary platform for a vast and diverse audience. UE applications have transcended traditional boundaries, attracting users and serious enthusiasts alike. One of the pivotal factors contributing to a rise in the mobile application is the inherent portability and accessibility that the UE offers, enabling users to engage in user experiences at any time and in any place.

A paradigm shift has led to a burgeoning sector within the mobile application known as real-time online mobile gaming (RT OMG). In the RT OMG, gaming resources are pre-downloaded onto a device, and local computation and hardware are utilized to render real-time applications. A fundamental component of the RT OMG is transmitting real-time data through a user datagram protocol (UDP). A connectionless protocol facilitates low-latency communication, making the connectionless protocol ideal for real-time applications. An instantaneous transmission of real-time data is critical for delivering the users a captivating and immersive user experience. Any packet loss or jitter in the real-time connection can affect the user experience.

Concurrently, the traffic, such as a download/upload and an on-demand video streaming, has surged recently. However, a coexistence of the NRT and the RT traffic on the same network link may introduce competition for bandwidth, potentially leading to suboptimal user experiences due to increased latency, jitter, and packet loss. Therefore, optimizing bandwidth allocation for the NRT traffic while ensuring minimal interference with RT traffic has emerged as a critical challenge in mobile applications. To address the challenge, a game stabilizer can be employed to manage and prioritize different types of traffic. In applications, where the RT traffic, requires low latency and minimal jitter, and the NRT traffic, such as downloads or video streaming, can tolerate higher delays, an effective game stabilizer becomes essential.

FIG. 1 illustrates a scenario depicting a game stabilizer of a user experience environment according to the related art.

Referring to FIG. 1, it illustrates a scenario 100 depicting the game stabilizer for a user experience environment. The existing game stabilizer 1.0 may include an application 102, a framework 104, a hardware abstraction layer (HAL) 106, a game stabilizer service 108, a game stabilizer controller 110, a traffic shaper 112, and a network framework 114.

The existing game stabilizer 1.0 is a heuristic-based technique to restrict background traffic and enhance a video calling experience during the NRT traffic. In the case of the game stabilizer 1.0, optimization for the application 102 (also referred to as “app”) bitrate is performed since the performance of the video calling is directly correlated to the app bitrate. Hence, in the existing game stabilizer 1.0, an NRT bandwidth is controlled based on a trend of the app bitrate. If an RT bit rate decreases, the NRT bandwidth should also be decreased and similarly if the NRT bandwidth decreases, the RT bit rate should also be decreased. However, adopting a similar approach for mobile application is not feasible since the real-time app bitrate is uncorrelated to latency. In addition, fluctuations in the NRT bandwidth can cause a latency experience to become unstable. The stability of the latency is as important as the actual value of the latency. When the latency is stable, the user can get used to a delay and accordingly, the user can consistently make his moves in a game (also referred to as an ‘online game’). Hence, a solution is required that allocates the optimal NRT bandwidth without many fluctuations in the latency.

FIG. 2 illustrates a scenario depicting a comparative graphical representation between application traffic and download according to the related art.

Referring to FIG. 2, a scenario 200 depicts a comparative graphical representation between application traffic and download. FIG. 2 shows a fluctuation in a priority traffic which is a result of a toggling of a background traffic. As a result of the fluctuation in application traffic and the background traffic, it becomes hard to estimate network conditions and further becomes hard to predict an end-to-end bandwidth. Therefore, such fluctuation in the application traffic and the background traffic may certainly impact the latency.

Further, with evolving UE applications, the users expect a seamless and uninterrupted user experience with fluid graphics, minimal latency, and responsive controls. However, as the UEs concurrently handle multiple types of network traffic, including the NRT activities like downloads, which can saturate the available network bandwidth, and the overall performance of the RT applications degrades. This results in unsatisfactory user experiences.

FIG. 3A illustrates a scenario depicting an impact on latency during a download happening in background of an ongoing real-time application according to the related art.

Referring to FIG. 3A, a scenario 300a depicts an impact on the latency during a download happening in the background of the ongoing real-time application. FIG. 3A corresponds to real-time application 1 with and without the NRT traffic. On the left side of FIG. 3A, it can be seen that the real-time application 1 was smooth and the user did not experience any lag or frame drops. However, on the right side of FIG. 3A, it can be seen that there is a download happening in the background while the real-time application 1 is being used. A poor signal icon is displayed by the real-time application 1 indicating the packet loss and a high latency that the RT traffic is experiencing. In simple words, the NRT traffic affects the performance of the real-time application wherein, the user struggles to time his moves and skills resulting in a poor user experience.

In context of the RT online mobile applications, every millisecond counts. Whether a critical move in a multiplayer battle or a precision shot in a first-person shooter, the RT data transmission is highly sensitive to latency and disruptions. The UDP is widely adopted for RT data transmission and further, the UDP embodies sensitivity by prioritizing speed over reliability. Any delay, jitter, or packet loss can severely impact the usage of the real-time applications, potentially leading to a frustrating user experience.

Differentiated services code point (DSCP) marking in the network assigns varying levels of priority to different types of traffic. Marking real-time traffic with a higher priority informs a router to prioritize the real-time traffic over other traffic. However, many application servers do not implement DSCP markings, and even when they do, these markings can be removed or altered as packets traverse the network. While solutions, such as the SCS and the MSCS allow the UE to request an access point (AP) to prioritize specific traffic, the routers that support these features are not yet widely adopted in real-world deployments. From the UE perspective, the solution is to automatically restrict NRT bandwidth during real-time traffic sessions. The current approach, which involves completely restricting the NRT traffic during the RT traffic, can be overly restrictive to the user. This leads to the underutilization of network resources, as the NRT traffic is entirely deprived of bandwidth, causing any substantial NRT traffic to be starved. Such restrictions, while preventing interference, may not efficiently balance network usage. Additionally, if the NRT traffic is not adequately managed, the NRT traffic can interfere with the RT traffic, ultimately degrading the user experience by causing congestion and higher latency during the usage of the real-time application. To address this imbalance, a negative feedback system can be introduced to dynamically adjust NRT traffic allocation.

FIG. 3B illustrates a scenario depicting a negative feedback system according to the related art.

Referring to FIG. 3B, it illustrates a scenario 300b depicting the negative feedback system. When the user using the real-time application manually adjusts an NRT allocation 301 through trial and error, as shown in FIG. 3B. Real-time condition 303 is an example of the negative feedback system of scenario 300b. The negative feedback system of scenario 300b may include a sensor 302, a controller 304, and a system 305. Output from the system 305 may be given to the sensor 302. The sensor 302 measures a target quantity, which is the latency, providing real-time data on network performance. The controller 304 processes information and compares the information to a reference value, determining whether adjustments are necessary. The controlling quantity, the NRT allocation 301, is then adjusted by the controller 304 to optimize the balance between the NRT and RT traffic. The player reduces the NRT allocation 301 until the application's latency improves. Once the user experience stabilizes, the player attempts to increase the allocation to improve download speeds. This process exemplifies a negative feedback loop in which the controlling quantity (C) is the NRT allocation 301, and the target quantity (T) is the latency, which is measured and compared against a reference value. The relationship between T (latency) and C (NRT allocation 301) can be direct or inverse, and the controller 304 (in this case, the user) adjusts the controlling quantity based on this relationship to optimize performance. However, this manual approach is inefficient and inconsistent, highlighting the need for an automated solution to dynamically manage traffic and optimize both real-time application performance and download speeds without user intervention. The game stabilizer works similarly to the above-mentioned negative feedback mechanism. However, the target variable (T) used in the game stabilizer is the app bitrate instead of the latency. The solution is proposed mainly for video calling. In the case of video calling, using the app bitrate is appropriate since the video quality improves with the app bitrate. When the app bitrate is low, video quality becomes grainy, and frames are dropped.

The RT OMG traffic is mainly the UDP and hence, unlike a transmission control protocol (TCP), latency-related parameters like a round trip time (RTT) are not easily available. To understand the feasibility of using the app bitrate as a measure of the user experience, the app bitrate data has been collected for multiple applications in different quality of experience (QoE) scenarios like poor, average, and good. Generating varying levels of the user experience depends on changes in the network conditions.

FIG. 4 illustrates a scenario depicting an app bitrate for various real-time applications in different quality of experience (QoE) conditions according to the related art.

Referring to FIG. 4, it illustrates a good network condition results in a good user experience whereas a poor network results in a laggy and a slow user experience. As shown in aa scenario 400 depicting the app bitrate for various applications in the different QoE conditions.

Referring to FIG. 4, the application bitrate does not quantify the QoE for the user. Hence, the application bitrates cannot be utilized to directly control the NRT bandwidth.

FIG. 5 illustrates a scenario depicting an app bitrate graphics and a frame rate for a real-time application 1 according to the related art.

Referring to FIG. 5, a scenario 500 depicts the app bitrate for varying settings of graphics and frame rates for the real-time application 1. FIG. 5 depicts the real-time application 1 like, where the real-time application 1 provides a method to modify the graphics (low, medium, high) and the frame rate (low, medium, high). Evaluating the app bitrate based on the different combinations of the graphics and the frame rate to check if any correlation exists. However, in all combinations (C0, . . . C8), the app bitrate does not constitute a valuable metric. In short, the QoE cannot be determined by the app bitrate or the app packet rate. Therefore, a new metric is required for the real-time application.

For example, online games typically open a TCP connection to support the RT UDP traffic by managing control functions, such as Keep-alive signals, activity checks, and connection verifications. The TCP protocols may maintain several parameters that are crucial for assessing and optimizing network performance. The several parameters may include RTT_AVG, RTT variance, receiver side predicted RTT (RCV_RTT), minimum RTT (MIN_RTT), and RETRANS (cumulative retransmissions) per connection. To calculate the current round-trip time (curRTT), a smoothed round-trip time (SRTT) and apply Karn's algorithm. The Karn's algorithm is used to adjust RTT measurements to account for the effects of retransmissions and ensure a more accurate estimate of network latency.

calculate the current RTT (curRTT) using the smoothened RTT (SRTT) using Karn's Algorithm as follows:

follows:

$$\begin{matrix}SRTT\_curr = ( 1 - α ) * curRTT + α * SRTT\_Prev where , α ( smoothening factor ) = 0.875 in Linux \\ curRTT = 8 * SRTT\_cur - 7 * SRTT\_prev\end{matrix}$$

For a few games, a slight correlation between TCP RTT and the onscreen latency may be observed, but multiple TCP ports being established, and infrequent updates of the TCP RTT values make it unreliable.

A media access control (MAC) level parameter and correlation with latency may be evaluated. Further, a correlation between MAC protocol data unit (MPDU) parameters and latency is being established based on the following conditions. The first condition is that RTT is correlated to transmit bad (TxBad) (referred to as MPDU transmit packet which is lost) and hence it may be useful as an indication of bad RTT. Further, as the second condition, TxRetries (referred to as MPDU transmit packet which is re-transmitted) and TxGood (referred to as MPDU transmit packet which is successful) were observed to be not correlated to RTT. However, TxBad does not always indicate when the user experience is poor.

Therefore, in light of the above-mentioned challenges, a method and a system are required to overcome above-mentioned challenges associated with the mobile user experience.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and method for managing traffic on a communication channel for a user equipment (UE).

Additional aspects will be set forth in part in the description which follows and, in part, will be apparent from the description, or may be learned by practice of the presented embodiments.

In accordance with an aspect of the disclosure, a method of an electronic device for managing traffic on a communication channel for a user equipment (UE) is provided. The method includes identifying real-time (RT) traffic and non-real-time (NRT) traffic associated with a plurality of applications on the UE, obtaining one or more network parameters and an end-to-end (EtE) bandwidth of the communication channel based on at least one of a historical EtE bandwidth estimate of the communication channel, the RT traffic, and the NRT traffic, predicting a bandwidth allocation for the NRT traffic and a bandwidth allocation for the RT traffic based on the obtained EtE bandwidth of the communication channel and the obtained one or more network parameters, and allocating an NRT bandwidth to the NRT traffic, and an RT bandwidth to the RT traffic based on the predicted bandwidth allocation for the NRT traffic and the predicted bandwidth allocation for the RT traffic

The method includes monitoring changes in the one or more network parameters and the EtE bandwidth over a period of time. The method includes updating the NRT bandwidth based on the monitored changes in the one or more network parameters and the EtE bandwidth.

The method includes fetching the historical EtE bandwidth estimate of the communication channel from a database associated with the UE. The database includes an average value of the EtE bandwidth for a plurality of previously connected communication channels associated with the UE.

The one or more network parameters includes one or more of a link speed, a received signal strength, and a frequency of the communication channel.

The method includes regulating the NRT traffic based on the bandwidth allocation corresponding to the NRT traffic and the RT traffic. The method includes enabling a flow of the RT traffic associated with the plurality of applications upon regulating the NRT traffic.

In accordance with an aspect of the disclosure, an electronic device for managing traffic on a communication channel for a user equipment (UE) is provided. The electronic device includes memory, including one or more storage media, storing instructions, and at least one processor communicatively coupled to the memory, wherein the instructions, when executed by the at least one processor individually or collectively, cause the electronic device to identify real-time (RT) traffic, and non-real time (NRT) traffic associated with a plurality applications on the UE, obtain one or more network parameters and an end-to-end (EtE) bandwidth of the communication channel based on at least one of a historical EtE bandwidth estimate of the communication channel, the RT traffic, and the NRT traffic, predict a bandwidth allocation for the NRT traffic and a bandwidth allocation for the RT traffic, based on the obtained EtE bandwidth of the communication channel and the obtained one or more network parameters, and allocate an NRT bandwidth to the NRT traffic, and an RT bandwidth to the RT traffic based on the predicted bandwidth allocation for the NRT traffic and the predicted bandwidth allocation for the RT traffic.

In accordance with an aspect of the disclosure, one or more non-transitory computer-readable storage media storing one or more computer programs including computer-executable instructions that, when executed by at least one or more processors of an electronic device individually or collectively, cause the electronic device to perform operations are provided. The operations include identifying real-time (RT) traffic and non-real-time (NRT) traffic associated with a plurality of applications on a user equipment (UE), obtaining one or more network parameters and an end-to-end (EtE) bandwidth based on at least one of a historical EtE bandwidth estimate of a communication channel, the RT traffic, and the NRT traffic, predicting a bandwidth allocation for the NRT traffic and a bandwidth allocation for the RT traffic, based on the obtained EtE bandwidth of the communication channel and the obtained one or more network parameters, and allocating an NRT bandwidth to the NRT traffic, and an RT bandwidth to the RT traffic based on the predicted bandwidth allocation for the NRT traffic and the predicted bandwidth allocation for the RT traffic.

Other aspects, advantages and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a scenario depicting a game stabilizer of a user experience environment according to the related art;

FIG. 2 illustrates a scenario depicting a comparative graphical representation between application traffic and download according to the related art;

FIG. 3A illustrates a scenario depicting an impact on latency during a download happening in background of an ongoing real-time application according to the related art;

FIG. 3B illustrates a scenario depicting a negative feedback system according to the related art;

FIG. 4 illustrates a scenario depicting an app bitrate for various real-time applications in different quality of experience (QoE) conditions according to the related art;

FIG. 5 illustrates a scenario depicting an app bitrate graphics and a frame rate for a real-time application 1 according to the related art;

FIG. 6 illustrates a schematic block diagram of an environment for managing traffic on a communication channel for user equipment (UE) according to an embodiment of the disclosure;

FIG. 7 illustrates a working of a network traffic management module according to an embodiment of the disclosure;

FIG. 8 illustrates a block diagram of a system for managing traffic on a communication channel for a UE according to an embodiment of the disclosure;

FIG. 9 illustrates optimal non-real-time (NRT) allocation according to an embodiment of the disclosure;

FIG. 10A illustrates a diagram depicting a correlation between a latency and network parameters according to an embodiment of the disclosure;

FIG. 10B illustrates a graphical representation of mean points used for obtaining a final relation between restriction for a background bandwidth and end-to-end speed according to an embodiment of the disclosure;

FIG. 10C illustrates a diagram depicting a multivariate linear regression according to an embodiment of the disclosure;

FIG. 11 illustrates a graphical representation of a NRT traffic according to an embodiment of the disclosure;

FIG. 12 illustrates a diagram depicting an end-to-end capacity estimation for an NRT traffic according to an embodiment of the disclosure;

FIG. 13 illustrates a flow diagram of a regressor according to an embodiment of the disclosure;

FIG. 14 illustrates a graphical representation of an effect on an application in various network conditions according to an embodiment of the disclosure;

FIG. 15 illustrates a graphical representation of a latency according to an embodiment of the disclosure;

FIG. 16 illustrates a table depicting an evaluation of a network traffic management module according to an embodiment of the disclosure;

FIGS. 17A and 17B illustrate a sequence flow depicting a method for managing a traffic on a communication channel for a UE according to various embodiments of the disclosure;

FIG. 18 illustrates a flowchart depicting a method for managing a traffic on a communication channel for a UE according to an embodiment of the disclosure;

FIG. 19A illustrates a scenario depicting a UE without using a network traffic management module according to an embodiment of the disclosure; and

FIG. 19B illustrates a scenario depicting a UE using a network traffic management module according to an embodiment of the disclosure.

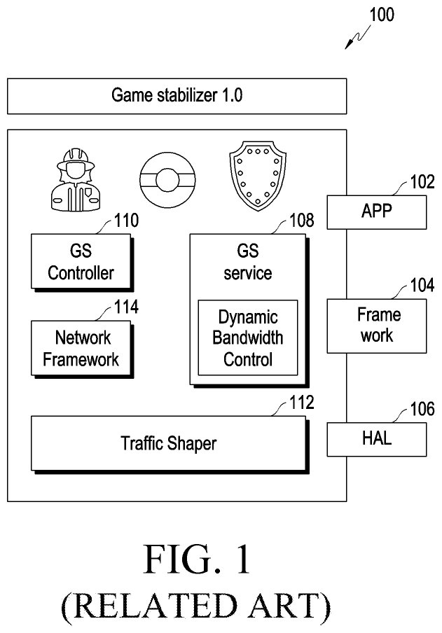

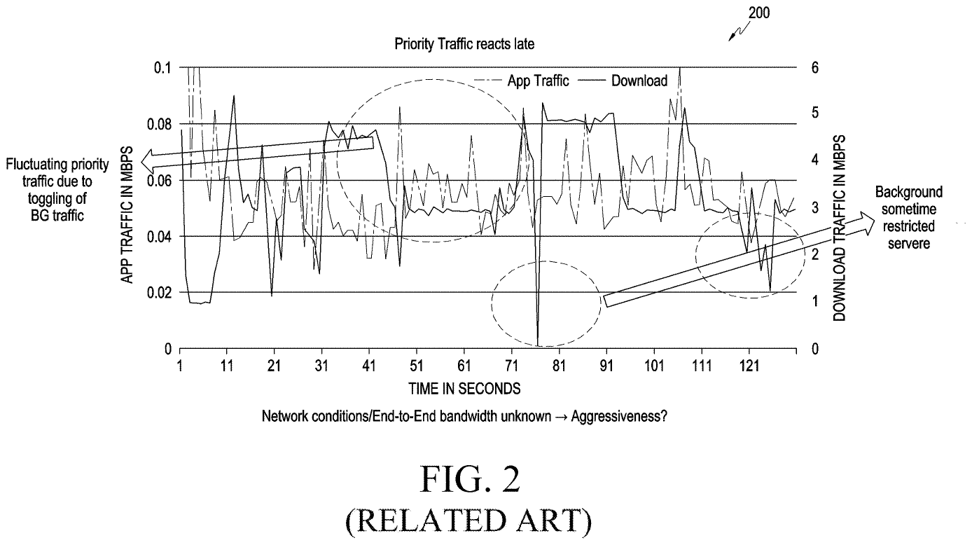

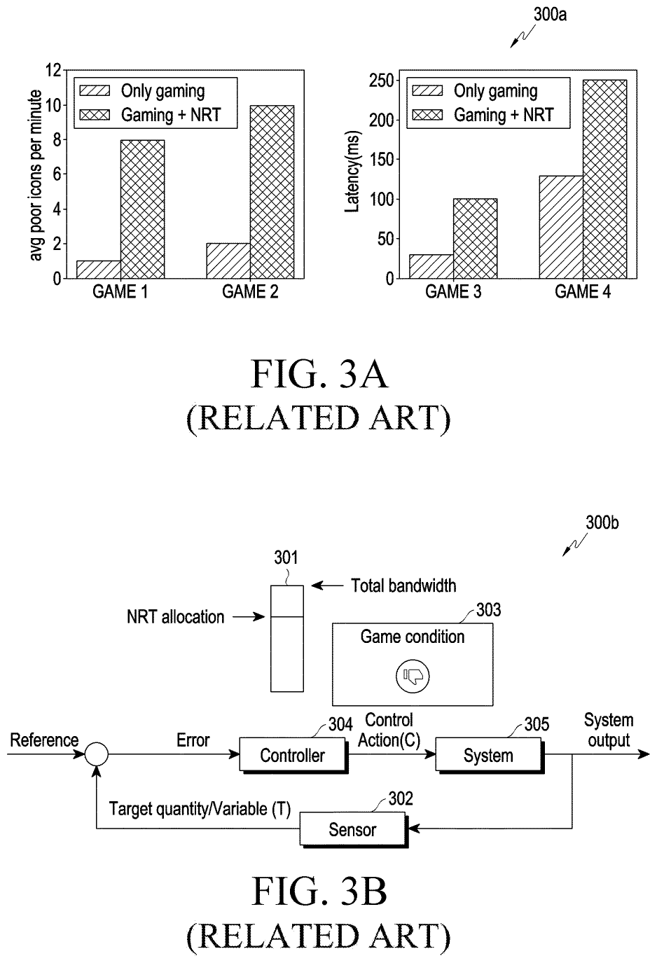

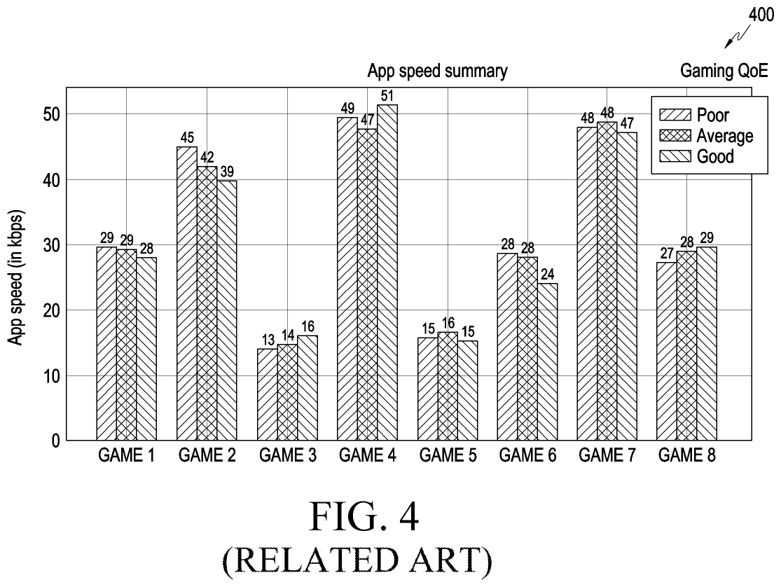

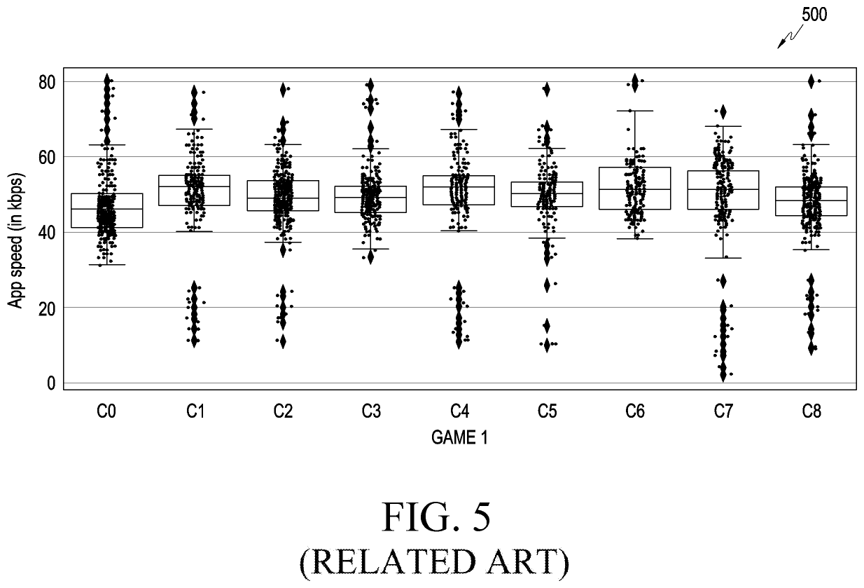

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, “has,” “have,” or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The terms “GS Controller”, and “Controller”, may be used as synonyms interchangeably throughout the description without deviating from the scope of the disclosure.

The terms “Regressor”, and “machine learning (ML) bandwidth controller” may be used as synonyms interchangeably throughout the description without deviating from the scope of the disclosure.

An objective of the disclosure is to provide techniques that can deliver an optimized user experience. The disclosed techniques leverage real-time data on network conditions and estimated end-to-end speeds. The disclosed techniques aim to dynamically allocate bandwidth for non-real-time (NRT) traffic, ensuring that real-time user experiences remain unaffected and the latency is minimized, thereby ultimately enriching the user experience for users.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

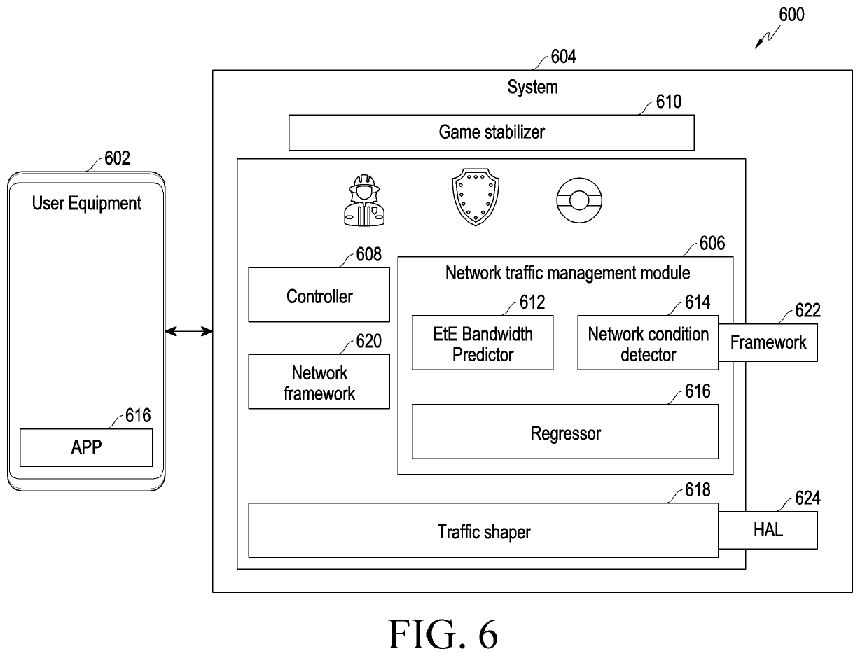

FIG. 6 illustrates a schematic block diagram of an environment of managing traffic on a communication channel for user equipment (UE) according to an embodiment of the disclosure.

Referring to FIG. 6, an environment 600 may include the UE 602, and a system 604. The system may be implemented in an electronic device including, for example, the UE 602 or a server. In an embodiment of the disclosure, the system 604 may reside in a server and may be in communication with the UE 602. In another embodiment of the disclosure, the system 604 may be a part of the UE 602. The system 604 may include a network traffic management module 606, a controller 608, a game stabilizer 610, an end-to-end (EtE) bandwidth predictor 612, a network condition detector 614, a regressor 616, a traffic shaper 618, a network framework 620, a framework 622, and a hardware abstraction layer (HAL) 624. The components of the system 604 may work in unison to optimize a user experience by dynamically managing bandwidth allocation for non-real-time (NRT) traffic and real-time (RT) traffic. The user experience may include, but is not limited to, gaming experience, and the like.

In an embodiment of the disclosure, the system 604 may be configured to identify the RT traffic and the NRT traffic associated with a plurality of applications on the UE 602. The plurality of applications may include real-time applications. The RT traffic may refer to data transmission that requires immediate processing and minimal delay, as the data is sensitive to time. The RT traffic typically may be associated with the plurality of applications, such as voice calls, video conferencing, online gaming, live streaming, and the like. The plurality of applications may need a continuous flow of data with low latency to function properly, as any delay or interruption can degrade the user experience. Further, the NRT traffic may refer to data that does not require immediate processing and may tolerate some delay without affecting the overall functionality. The NRT traffic may include but is not limited to, Email, file downloads/uploads, background data synchronization, social media updates, and the like. The NRT traffic may be buffered or queued without significantly impacting the user experience, making it less sensitive to delays compared to the RT traffic.

In one or more embodiments of the disclosure, the system 604 may include the network condition detector 614 configured to detect network parameters based on the RT traffic, and the NRT traffic. The network parameters may include but are not limited to, a wireless network throughput, a received signal strength, a frequency of a communication channel, and the like. The communication channel may refer to a pathway or medium through which data is transmitted between the UE 602 (such as a smartphone or tablet) and a network (like a base station or Wi-Fi router). The communication channel may include various physical and logical layers that facilitate the transfer of data packets between the UE 602 and the network.

In one or more embodiments of the disclosure, the system 604 may be configured to detect an end-to-end (EtE) bandwidth of the communication channel based on a historical EtE bandwidth estimate of the communication channel, the RT traffic, and the NRT traffic. The EtE bandwidth may refer to the total available data transmission capacity across the communication channel from a source to a destination. For example, the EtE bandwidth may represent maximum rate at which data can be transmitted over a network, considering all intermediate links, devices, and potential bottlenecks, the EtE bandwidth may be crucial for determining how efficiently data may be transferred between two points in the network, such as from the server to the UE 602. Further, the historical EtE bandwidth estimate may be calculated or recorded as an average of the EtE bandwidth over a series of previous connections or transmissions. The historical EtE bandwidth estimate may be based on past measurements of the bandwidth across the same or similar communication channels. The historical EtE bandwidth estimate may provide a reference for predicting future bandwidth availability and help in optimizing network resource allocation by understanding typical network performance over time. The historical EtE bandwidth estimate may be especially useful for adjusting traffic management strategies to improve overall data flow and user experience.

The system 604 may be configured to monitor changes in the network parameters and the end-to-end bandwidth over a period of time. Further, the system 604 may be configured to update the NRT bandwidth allocation based on the monitored changes in the network parameters and the end-to-end bandwidth. The system 604 may be configured to regulate the NRT traffic based on the bandwidth allocation for the NRT traffic and the RT traffic. The NRT traffic may be regulated to a threshold value that may not exceed a predefined or calculated value. This is achieved by either dropping excess NRT traffic or introducing an additional delay to manage the NRT traffic flow. Furthermore, the system 604 may be configured to enable a flow of the RT traffic associated with the plurality of applications upon regulating the NRT traffic for enhancing the user experience for the user on the UE 602.

In one or more embodiments of the disclosure, the network traffic management module 606 may be driven by a robust machine learning (ML) Engine, which is the core component for intelligent bandwidth allocation. Further, the EtE bandwidth predictor 612 may be configured to measure speed of the EtE bandwidth.

In an embodiment of the disclosure, the system 604 may include the EtE bandwidth predictor 612 configured to predict a EtE bandwidth. The regressor 616 may be configured to predict or calculate a bandwidth allocation for the NRT traffic, a bandwidth allocation for the RT traffic based on the detected end-to-end bandwidth of the communication channel, and the detected network parameters. Further, the system 604 may be configured to allocate the NRT bandwidth to the NRT traffic, and the RT bandwidth to the RT traffic based on the predicted bandwidth allocation for the NRT traffic and the RT traffic for enhancing the user experience for the user on the UE 602. The allocation of the NRT bandwidth may include receiving the predicted bandwidth allocation for the NRT traffic.

In one or more embodiments of the disclosure, the controller 608 may be a lightweight module responsible for turning the network traffic management module 606 on and off based on detected RT traffic. The network framework 620 may be configured to provide necessary information about link conditions. The traffic shaper 618 may be configured to restrict NRT traffic to the allocation set by the network traffic management module 606. A communication device framework may fetch a foreground application context. The controller 608 may be configured to efficiently identify an active RT application session, ensuring that the network traffic management module 606 is activated to optimize bandwidth allocation.

In one or more embodiments of the disclosure, the regressor 616 may serve as the core intelligence of the network traffic management module 606. The regressor 616 may include an ML bandwidth controller. The regressor 616 may operate as a regressor model, utilizing the predicted network condition category and estimated EtE speed to determine the optimal threshold for non-real traffic, minimizing any adverse impact on the RT traffic.

In one or more embodiments of the disclosure, the data may be collected in different conditions for network diversity. The regressor 616 may be more robust to change the network parameters and work universally. The end-to-end speed of a link is fixed and the network traffic management module 606 may be configured to iterate over the set of NRT allocations. For each NRT allocation, a target application may be played for 120 seconds along with a Play Store download in the background. Further, the network traffic management module 606 may be configured to collect measurements of the network parameters. For example, the collected data for real-time applications, such as call of duty (COD) and player unknown's battlegrounds (PUBG) on the play store. Out of 43,200 samples collected, outliers and invalid samples may be discarded, resulting in 39,000 valid samples for analysis. The below Table 1 represents the example sample from the data:

TABLE 1

| ETE | RSSI | LS | Frequency | NrtA | RTT |
|---|---|---|---|---|---|
| 20 MBPS | −73 | 28 MBPS | 2.4 GHz | 10 Mbps | 80 ms |

In one or more embodiments of the disclosure, the traffic shaper 618 may be used for shaping the NRT traffic. An extended Berkeley packet filter (eBPF) based filter is used to differentiate the RT traffic from NRT traffic based on the Internet protocol (IP) address of the packets.

The framework 622 may include but is not limited to the controller 608, the network traffic management module 606, and the traffic shaper 618. These components work in unison to optimize the user experience by dynamically managing the bandwidth allocation for the RT and the NRT. The HAL 624 may be a software layer that sits between the hardware of the UE 602 and an operating system or the plurality of applications. The primary purpose of the HAL 624 is to abstract, or hide, the complexities of the underlying hardware, providing a uniform interface that the operating system or plurality of applications can use to interact with different types of hardware without needing to know the specific details of the hardware components.

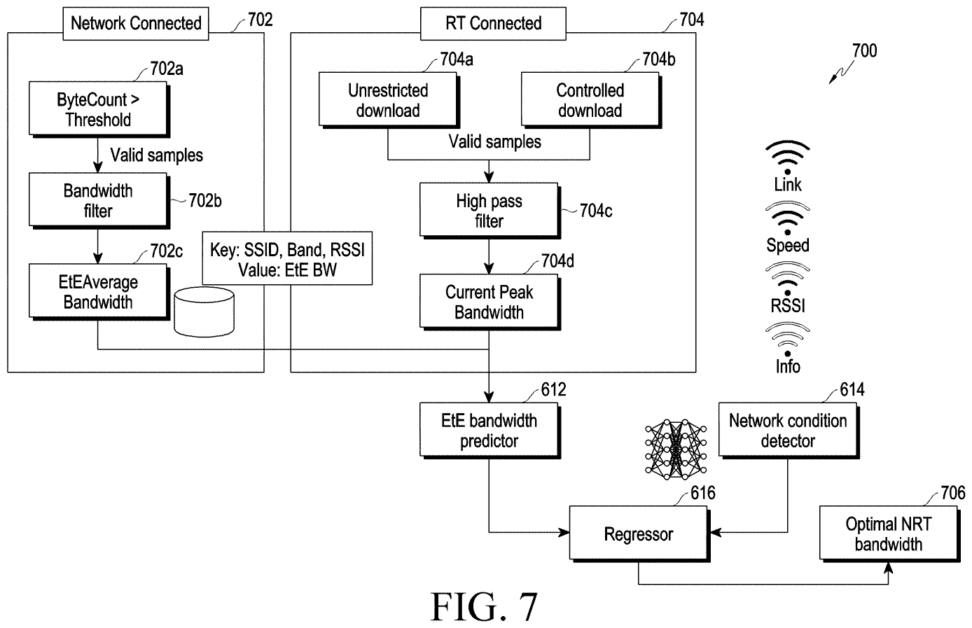

FIG. 7 illustrates a working of a network traffic management module according to an embodiment of the disclosure.

Referring to FIG. 7, the EtE bandwidth of the current network may be estimated for effective bandwidth allocation. The EtE bandwidth predictor 612 may be configured to use two estimates, i.e., a first estimate 702, and a second estimate 704 in the calculation of the final EtE speed. The first estimate 702 may include a condition “Byte Count>Threshold” 702a and may refer to a scenario where the amount of data (measured in bytes) that has been transmitted or received exceeds a predefined limit or threshold value. Valid samples may be collected from the Byte Count>Threshold” 702a to a bandwidth filter 702b. The valid samples may include, but are not limited to, bandwidth samples, and the like. The samples of total bitrate on the UE 602, which includes RT rate and NRT rate. The valid samples may be passed to the bandwidth filter 702b and a high pass filter 704c. The valid samples may update the historical EtE bandwidth estimate.

The bandwidth filter 702b may be configured to store unique values for each service set identifier (SSID) and the network parameters (e.g., received signal strength indicator (RSSI) level, frequency, bandwidth). For example, the bandwidth filter 702b stores data of outlier adjusted peak bitrate per network and signal condition. The first estimate 702 includes an average historical EtE bandwidth 702c calculated under the network parameters. The second estimate 704 may include measuring the peak bitrate of ongoing traffic (for example, the RT traffic, and the NRT traffic). The second estimate 704 may be determined based on the RT traffic, and the NRT traffic. For example, the second estimate 704 may include the current ongoing RT traffic and NRT traffic values. The current estimate 704 may be useful for the dynamic network conditions whereas the historical estimate may be useful for the case of slow server restricted downloads. The valid samples may be collected from both unrestricted download 704a and controlled download 704b and fed to the high pass filter 704c. The unrestricted download 704a may refer to a current bandwidth measurement when there are no restrictions on the NRT traffic, allowing for an accurate estimate of the available bandwidth. The controlled download 704b may refer to the bandwidth measurement when the NRT traffic is being restricted or controlled to prioritize the RT traffic, providing insights into how bandwidth allocation changes under traffic management. The high pass filter 704c may be applied to eliminate any low-frequency fluctuations or noise in the bandwidth measurements, ensuring that only significant changes in traffic or network conditions are considered. The current peak bandwidth 704d may refer to the highest measured bandwidth in real-time, capturing the maximum available speed of the current traffic conditions.

FIG. 7 includes the network condition detector 614 which is a critical module that assesses the prevailing network conditions, considering the network parameters, such as the wireless network throughput, signal strength, frequency, and frame parameters. The information on prevailing network conditions may be crucial in determining the predicted network condition, categorized as excellent, average, or poor. Based on the determined network condition, the network traffic management module 606 may optimize the bandwidth allocation to minimize the impact on the real-time traffic.

In one or more embodiments of the disclosure, the regressor 616 may serve as the core intelligence of the network traffic management module 606. The regressor 616 may be configured to operate as a regressor model, utilizing the predicted network condition category and estimated EtE speed to determine the optimal NRT bandwidth 706 for non-real traffic, minimizing any adverse impact on the RT traffic. For training the regressor 616, as an example, data may be collected from multiple real-time applications under various network conditions. For each application, in end-to-end speed settings, an average latency may be collected for different settings of NRT bandwidth. The average latency data may help in assessing the impact of various NRT bandwidth settings on the application's performance. Based on the analysis, the optimal NRT bandwidth 706 may be selected in each instance to provide balanced latency performance along with a reasonable NRT bandwidth. The optimal NRT bandwidth 706 may be transmitted to the traffic shaper 618.

In one or more embodiments of the disclosure, the traffic shaper 618 may be used for shaping the NRT traffic. More particularly, an extended Berkeley packet filter (eBPF) based filter may be used to differentiate the RT traffic from the NRT traffic based on the IP address of the packets. The traffic from the IP addresses associated with an application with real-time traffic, such as gaming application may be allowed to flow freely, while the traffic from the other IP addresses (the NRT traffic) may be regulated to ensure the NRT traffic does not exceed the NRT bandwidth limit set by the regressor 616.

In one or more embodiments of the disclosure, In the case of a cellular network, the_network parameters, such as radio access technology (RAT), signal-to-interference-plus-noise ratio (SINR), RSSI, channel state information (CSI), carrier aggregation (CA), a radio resource block (RB), cellular ID (Cell ID) number may be used to determine the network condition. Upon connecting to the network (for example, the cellular network), the network traffic management module 606 may be activated. This is because the RT traffic may or may not commence immediately upon connection. However, a primary factor influencing the EtE bandwidth is the presence of saturated traffic within the network. As a result, regardless of whether the RT traffic is active, the EtE bandwidth may be estimated and predicted. The predictive capability may allow the system 604 to anticipate network performance and allocate resources efficiently, ensuring that optimal bandwidth is available for RT and NRT data transmissions, even under varying traffic conditions.

During the evaluation of EtE bandwidth estimation, a high occurrence of false positive (FP) alarms may be observed. The FP alarms may be caused by thin stream connections. The thin stream connections may be characterized by low-volume or burst traffic, such as messages, background synchronization, and data feeds. The traffic types may not reflect the actual bandwidth and may distort the overall bandwidth average. To mitigate the traffic, a cutoff value and filtering mechanism (the bandwidth filter 702b the high pass filter 704c) may be implemented to collect the valid samples. For instance, certain types of downloads, such as Telegram Downloads®©, are restricted by server limitations and do not reach maximum bandwidth. The filtering mechanism may be configured to differentiate between thin traffic, which represents limited data flow, and thick traffic, which is subject to server restrictions. Invalid samples and outliers may be filtered out to achieve an EtE accuracy rate exceeding 95%.

Furthermore, the EtE bandwidth averages may fluctuate across different network conditions, even within the same network. For example, the user connected to the network may experience 100 Mbps in an office setting, 80 Mbps at home, and varying speeds within different rooms of the same house (e.g., 60 Mbps in the living room and 40 Mbps in the bedroom). To address these variations, a unique key may be generated to identify and store individual speed values.

Initially, the system 604 may store the cell ID number along with the RAT, such as fourth-generation (4G) or fifth-generation (5G), as a key in a database. This approach identifies most network conditions. However, in some cases, regions with the same cell ID number and RAT may exhibit varying bandwidth values. To enhance accuracy, additional parameters, such as the SINR, the RSSI, the CSI, and the CA, may be collected and encoded using a one-hot encoding technique. The one-hot encoding technique may represent categorical variables as numerical values in the regressor 616. An encoded value may be used to determine the optimal NRT bandwidth under different conditions. For example, in cases where the RSSI is poor, the optimal NRT bandwidth may be lower, whereas, in situations where the RSSI is excellent and contention is minimal, the optimal NRT bandwidth may be higher within the cell ID and RAT scenario. The system 604 may utilize the ML models trained on the network conditions to detect the optimal NRT bandwidth.

Currently, linear regression and supervised learning models, such as neural networks and extended gradient boosting (XGBoost) may be used for predicting the optimal NRT bandwidth. Additionally, the implementation of federated learning (FL) or reinforcement learning (RL) may further improve performance in future versions of the system 604.

The network traffic management module 606 may adopt an event-driven approach. The event-driven approach may be triggered only by specific events rather than constantly running in the background. When the UE 602 connects to the network, either via Wi-Fi or a cellular connection, the algorithm remains inactive until the RT traffic flow occurs. At this point, the network traffic management module 606 initiates its operations. The event-driven approach may avoid pitfalls associated with continuous polling. Continuous polling may refer to the practice of repeatedly querying the system 604 or device for updates or changes, often resulting in unnecessary resource consumption, increased latency, and reduced overall performance.

The network traffic management module 606 may include a reactive mechanism, ensuring that the network traffic management module 606 activates when necessary. The network traffic management module 606 may minimize the consumption of the system 604 resources, optimizing overall network efficiency. The network traffic management module 606 may significantly reduce the computational load on the UE 602, leading to improved performance and a smoother user experience. Additionally, this reactive approach helps conserve battery life, as the network traffic management module 606 is triggered by specific traffic conditions rather than continuously operating in the background, ensuring more efficient resource management in the network. Overall, the event-driven nature of the network traffic management module 606 may offer several advantages over continuous polling methods, including improved system performance, reduced power consumption, and enhanced user experience. The network traffic management module 606 may be configured to engage only when required, optimize functionality, and ensure efficient operation within the constraints of the UE 602.

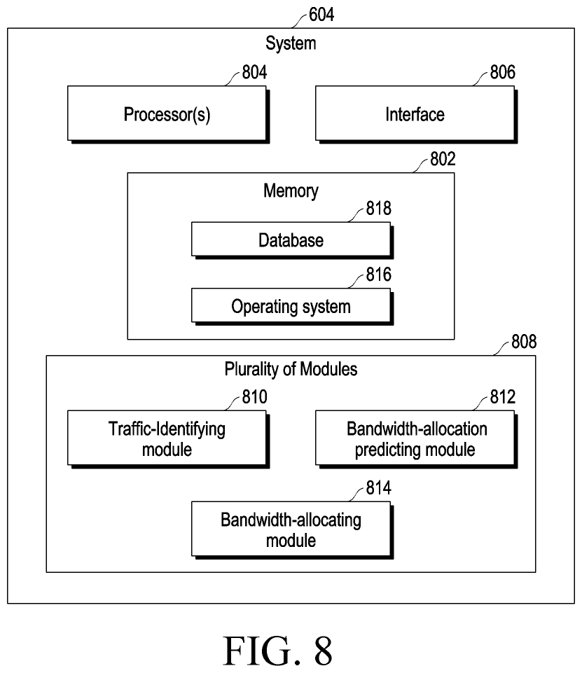

FIG. 8 illustrates a block diagram of a system for managing traffic on a communication channel for a UE according to an embodiment of the disclosure.

Referring to FIG. 8, the system 604 may include but is not limited to, a processor 804, memory 802, an interface 806, and a plurality of modules 808. The memory 802, the interface 806, and the plurality of modules 808 may be coupled to the processor 804. In an embodiment of the disclosure, the plurality of modules 808 may include a traffic-identifying module 810, a bandwidth-allocation predicting module 812, and a bandwidth-allocating module 814. The plurality of modules 808 and their work is further explained with reference to FIG. 8.

The processor 804 can be a single processing unit or several units, all of which could include multiple computing units. The processor 804 may be implemented as one or more microprocessors, microcomputers, microcontrollers, digital signal processors, central processing units, state machines, logic circuitries, and/or any device that manipulates signals based on operational instructions. Among other capabilities, the processor 804 is configured to fetch and execute computer-readable instructions and data stored in the memory 802.

The memory 802 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. Further, the memory 802 may include an operating system 816 for performing one or more tasks of the system 604, as performed by a generic operating system in the communications domain. Further, the system 604 may be configured to fetch the historical end-to-end bandwidth estimate of the channel from the database 818 associated with the UE 602. The database 818 may include an average value of the end-to-end bandwidth for a plurality of previously connected channels associated with the UE 602.

The plurality of modules 808 amongst other things, includes routines, programs, objects, components, data structures, or the like, which perform particular tasks or implement data types. The plurality of modules 808 may also be implemented as, signal processor(s), state machine(s), logic circuitries, and/or any other device or component that manipulates signals based on operational instructions.

Further, the plurality of modules 808 can be implemented in hardware, instructions executed by a processing unit, or by a combination thereof. The processing unit can comprise a computer, a processor, such as the processor 804, a state machine, a logic array, or any other suitable wearable device capable of processing instructions. The processing unit can be a general-purpose processor which executes instructions to cause the general-purpose processor to perform the required tasks or, the processing unit can be dedicated to performing the required functions. In another embodiment of the disclosure, the plurality of modules 808 may be machine-readable instructions (software) which, when executed by a processor/processing unit, perform any of the described functionalities.

In some embodiments of the disclosure, the plurality of modules 808 may include a set of instructions that may be executed to cause the system 604 to perform any one or more of the methods disclosed herein. The plurality of modules 808 may be configured to perform the steps of the disclosure using the data stored in the memory 802 to manage traffic on a communication channel for the UE 602, as discussed throughout this disclosure. In an embodiment of the disclosure, each of the plurality of modules 808 may be hardware units that may be outside the memory 802.

In an embodiment of the disclosure, the traffic-identifying module 810 may be configured to identify the RT traffic and the NRT time traffic associated with the plurality of applications on the UE 602 using the UE 602. The bandwidth-allocation predicting module 812 may be configured to predict the bandwidth allocation for the NRT traffic, a bandwidth allocation for the RT traffic, based on the detected EtE bandwidth of the communication channel and the detected one or more network parameters.

In an embodiment of the disclosure, the bandwidth-allocating module 814 may be configured to allocate the NRT bandwidth to the NRT traffic, the RT bandwidth to the RT traffic based on the predicted bandwidth allocation for enhancing the user experience for the user on the UE 602.

The plurality of modules 810, 812, and 814 may be in communication with each other. In an embodiment of the disclosure, the plurality of modules 810, 812, and 814 may be a part of the processor 804. In another embodiment of the disclosure, the processor 804 may be configured to perform the functions of modules 810, 812, and 814.

At least one of the modules 810, 812, and 814 may be implemented through an artificial intelligence (AI) model. A function associated with AI may be performed through the non-volatile memory, the volatile memory, and the processor 804. Accordingly, the processor 804 may include a plurality of processors. At this time, the plurality of processors may be a general purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU). The plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning technique to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to make determination or prediction. Examples of learning techniques include, but are not limited to, supervised learning, unsupervised learning, semi-supervised learning, or reinforcement learning.

According to the disclosure, in a method of managing network traffic for the UE 602, the method for optimizing bandwidth allocation between the RT and the NRT traffic may use an artificial intelligence model to predict and dynamically adjust the bandwidth allocation for enhancing the user experience. The processor may perform a pre-processing operation on the data to convert the data into a form appropriate for use as an input for the artificial intelligence model. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction is a technique of logical reasoning and predicting by determining information and includes, e.g., knowledge-based reasoning, optimization prediction, preference-based planning, or recommendation.

It should be noted that the system 604 may be a part of the UE 602. In another embodiment of the disclosure, the system 604 may be connected to the UE 602. In such embodiment of the disclosure, the UE 602 may be a device designed to manage traffic on the communication channel.

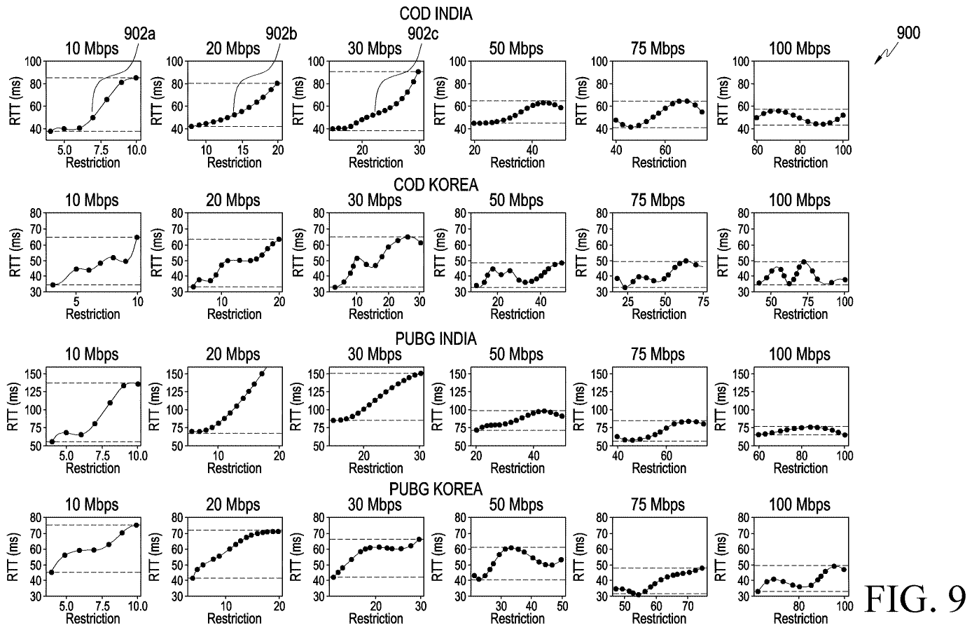

FIG. 9 illustrates optimal NRT allocation 900 according to an embodiment of the disclosure.

Referring to FIG. 9, the latency may be used as a QoE indicator for evaluating the user experience. In each tested EtE and the network condition, the optimal restriction may be determined using an elbow method, with highlighted samples 902a, 902b, and 902c representing the optimal NRT allocations. For each EtE speed and network link condition, an output variable may be identified as the optimal NRT allocation.

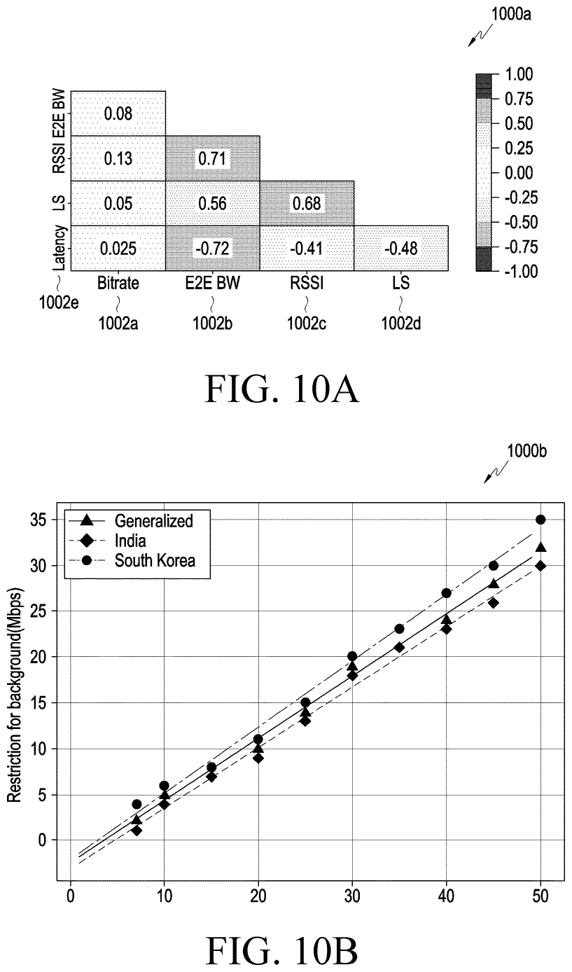

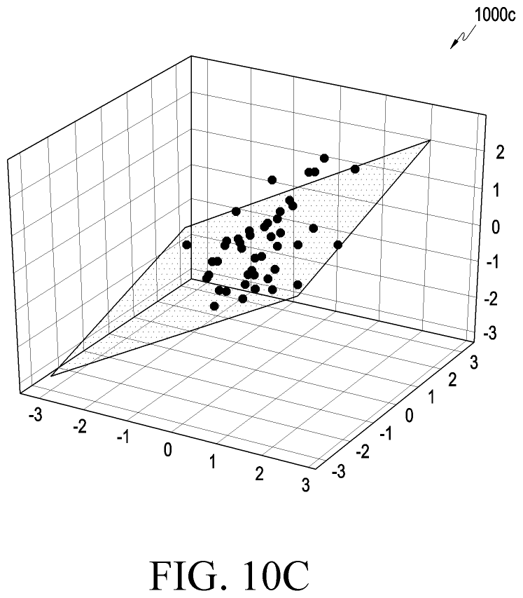

FIG. 10A illustrates a diagram 1000a depicting a correlation between a latency and network parameters according to an embodiment of the disclosure.

Referring to FIG. 10A, to select the network parameters for training the regressor 616, the correlation between the latency 1002e and the network parameters 1002a, 1002b, 1002c, and 1002d may be calculated. The application bitrate 1002a may show no significant correlation with the latency 1002e. The EtE bandwidth 1002b may exhibit the highest correlation, while the network parameters, such as a received signal strength indicator (RSSI) 1002c and the wireless network throughput 1002d, may be related to the latency 1002e.

FIG. 10B illustrates a diagram 1000b depicting a graphical representation of mean points used for obtaining a final relation between restriction for a background bandwidth and end-to-end speed according to an embodiment of the disclosure.

Referring to FIG. 10B, as an example, the data may be collected in both India and Korea and the mean points may be used to obtain the final relation. The following graph of FIG. 10B shows the best-fit lines obtained for Indian and Korean data and also the generalized line. The EtE bandwidth 1002b may be highly correlated to the latency 1002e. The regressor 616 may achieve good accuracy, with a mean squared error (MSE) of 1.28, despite its simplicity. However, as shown in FIG. 10B, the optimal NRT allocations vary with network conditions across different regions, highlighting the importance of incorporating network link information in the regressor 616. In an embodiment of the disclosure, the data from all the real-time applications are combined into one optimal value for one EtE speed as shown in Table 2.

TABLE 2

| EtE speed | India | Korea | Generalized |
|---|---|---|---|
| 7 | 1 | 4 | 2 |
| 10 | 4 | 6 | 5 |
| 15 | 7 | 8 | 8 |
| 20 | 9 | 11 | 10 |
| 25 | 13 | 15 | 14 |
| 30 | 18 | 20 | 19 |
| 35 | 21 | 23 | 21 |
| 40 | 23 | 27 | 24 |
| 45 | 26 | 30 | 28 |
| 50 | 30 | 35 | 32 |

FIG. 10C illustrates a diagram 1000c depicting a multivariate linear regression according to an embodiment of the disclosure.

Referring to FIG. 10C, after incorporating the network parameters into the input, the MSE may be reduced to 0.32, indicating the ability to reliably predict the optimal NRT allocation based on the network parameters. Linear regression may be chosen due to high accuracy, driven by the strong correlation between input and output parameters. The regressor 616 may be lightweight, resulting in minimal processing cost and latency.

In one or more embodiments of the disclosure, during data collection, experiments may be conducted in controlled EtE bandwidth settings, allowing for precise knowledge of the EtE speed. However, in real-time scenarios, the EtE bandwidth predictor 612 must calculate the value without direct measurement. The standard procedure for determining EtE bandwidth may involve performing a speed test, where dedicated saturating traffic is sent to the server, and the maximum throughput is measured. In contrast, the goal is to implement a non-intrusive mechanism that does not generate additional traffic while still accurately predicting the EtE bandwidth.

In one or more embodiments of the disclosure, a significant amount of background traffic, particularly downloads, behaves similarly to speed test traffic by attempting to saturate the link and utilize the total available bandwidth. To estimate the EtE bandwidth in a non-intrusive manner, restrictions on the NRT traffic may be periodically lifted for short intervals (3-5 seconds). Once the NRT traffic stabilizes, the total bitrate may be measured, and the EtE bandwidth may be estimated to be equal to the stabilized bitrate.

In one or more embodiments of the disclosure, the prediction of EtE bandwidth may be performed based on the restrictions that are a simple function of a single variable. Periodically, the NRT traffic may be unrestricted for a short duration of time. During this period the NRT traffic may try to utilize the maximum bandwidth available until the download bitrate of NRT traffic stabilizes (usually 3 to 6 secs). Once the NRT traffic reaches the stable point, the peak value may be estimated as the maximum bitrate achieved during the cycle. Further, the application may not suffer much in the short duration of 3-5 seconds. Furthermore, a value of 90 seconds is fixed based on the estimated peak value. The value of 90 seconds comprises 3-5 seconds of recalibration time and 85-87 seconds of restriction time.

In one or more embodiments of the disclosure, for example, Tables 3 and 4 depict an estimation when the UE 602 is in mobility. When the UE 602 is in mobility, the EtE bandwidth fluctuates. The EtE bandwidth increases as the UE 602 moves closer to an access point (AP). Further, the EtE bandwidth decreases as the UE 602 moves farther away from the AP. For example, the initial 3-second duration for recalibration may be found to be insufficient in a few cases. The rule may be applied, causing the EtE bandwidth estimate to stop increasing after 3 seconds. To address this, a dynamic recalibration timer of up to 5 seconds may be introduced. The extended recalibration duration may provide a more accurate EtE bandwidth estimate. Additionally, the recalibration duration may be increased by another 2 seconds as the download traffic continues to rise. A recalibration cycle duration of 180 seconds is insufficient for obtaining timely bandwidth updates in such cases. Therefore, changes in the RSSI may be monitored, and if a significant difference of more than 10 dB is detected, an immediate recalibration may be triggered, and the recalibration cycle is shortened to 90 seconds.

TABLE 3

| NRT | NRT | EtE bandwidth | |
|---|---|---|---|
| bitrate | Allocation | estimate | isRestricted |
| 12735 | 6 | 12 | 0 |
| 27091 | 24 | 26 | 0 |
| 21903 | 24 | 26 | 0 |
| 33745 | 21 | 33 | 1 |
| 14388 | 21 | 33 | 1 |

TABLE 4

| RT | NRT | NRT | EtE bandwidth | |
|---|---|---|---|---|
| bitrate | bitrate | Allocation | estimate | isRestricted |
| 46 | 59 | 43 | 59 | 0 |
| 46 | 50 | 37 | 50 | 0 |
| 52 | 64 | 47 | 64 | 0 |
| 46 | 70 | 51 | 70 | 0 |
| 47 | 77 | 57 | 77 | 0 |
| 50 | 51 | 51 | 77 | 1 |

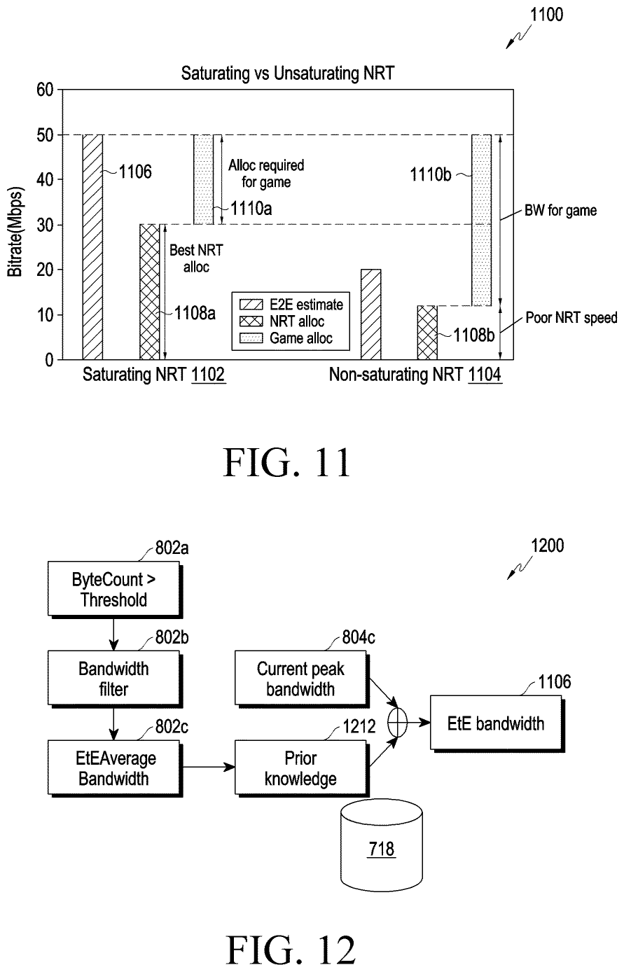

FIG. 11 illustrates a diagram depicting a graphical representation of NRT traffic according to an embodiment of the disclosure.

Referring to FIG. 11, a graphical representation 1100 may include saturating the NRT 1102, the non-saturating NRT 1104, the EtE bandwidth estimate 1106, NRT allocation 1108a, 1108b, and bandwidth allocation required for the real-time application 1110a, 1110b. The recalibration method may provide a reliable estimate of EtE bandwidth 1106 when dealing with the saturating NRT traffic 1102, such as downloads. However, if the NRT traffic is non-saturating NRT 1104 (under-utilizing the bandwidth), the estimate may be inaccurate. In such cases, a lower peak throughput may be estimated, leading to bandwidth restrictions that improve the user experience but significantly impact download speeds. The historical EtE bandwidth estimate may be especially useful for adjusting traffic management strategies to improve overall data flow and the user experience.

FIG. 12 illustrates a diagram 1200 depicting an end-to-end capacity estimation for an NRT traffic according to an embodiment of the disclosure.

Referring to FIG. 12, in an embodiment of the disclosure, to overcome the challenges, prior knowledge of the network 1212 may be used, by utilizing EtE average bandwidth in a given network condition of a specific network. The database 718 may include SSID values, RSSI values, bandwidth values, and EtE bandwidth values.

In one or more embodiments of the disclosure, prior knowledge of the network 1212 is based on the historical average of speed categorized into bins based on Band (2.4/5), link (Tx/Rx) and RSSI signal levels (0 to 4). Further, restrictions may be made to make sure that the server-restricted downloads do not affect the value. The bitrate below a certain threshold may not be filtered to avoid false negative updates.

In one or more embodiments of the disclosure, further tuning of the EtE prediction may include adding max link speed as an upper limit when end-to-end speed estimation is greater than the wireless network throughput value (referred to as speed of the network link (L2 speed)).

In an embodiment of the disclosure, the evaluation of a non-saturating (underutilized) server comprises the network that is able to utilize up to 50 Mbps bandwidth. However, in the scenario, the specific bitrate of the server may not be more than 25 Mbps. Further, a telegram download is used from a far-bad server which underutilizes the available bandwidth.

In an embodiment of the disclosure, the evaluation of a saturating download may include using an application store like a Play Store for downloading from a near-good server that fully utilizes the available bandwidth. The network is able to utilize up to 50 Mbps bandwidth. However, in the an embodiment of the disclosure, the bitrate of the server may also utilize up to 50 Mbps bandwidth. The EtE bandwidth filter may use the peak throughput from the recalibration logic along with the prior knowledge to dynamically predict the EtE bandwidth.

In one or more embodiments of the disclosure, the example Table 5 depicts the application download from the server with a specific bitrate, showing a usage speed, indicating unsaturating (under-utilization) of the available bandwidth, in accordance with an embodiment of the disclosure. The application (for example, telegram) downloads from the server with the specific bitrate, usage of 22 Mbps out of 50 Mbps shown in below Table 6, indicating under-utilization of the available bandwidth. Prior knowledge improves the NRT bitrate in cases of server-restricted downloads.

TABLE 5

| | | | | | Historical | Restriction | | |
|---|---|---|---|---|---|---|---|---|
| | | | Current EtE | Restriction | EtE | using | Final EtE | |
| | RT | NRT | bandwidth | using | bandwidth | Historical | bandwidth | |
| Time | bitrate | bitrate | estimate | Current EtE | estimate | EtE | estimate | isRestricted |
| 166 | 85 | 14 | 21 | 13 | 49 | 34 | 49 | 1 |
| 167 | 66 | 22 | 22 | 13 | 49 | 34 | 49 | 1 |
| 168 | 63 | 17 | 22 | 13 | 49 | 34 | 49 | 1 |
| 169 | 80 | 20 | 22 | 13 | 49 | 34 | 49 | 1 |
| 170 | 81 | 18 | 22 | 13 | 49 | 34 | 49 | 1 |
| 171 | 75 | 16 | 22 | 13 | 49 | 34 | 49 | 1 |
| 172 | 86 | 17 | 22 | 13 | 49 | 34 | 49 | 1 |
| 173 | 72 | 17 | 22 | 13 | 49 | 34 | 49 | 1 |

TABLE 6

| | Without prior | With prior |
|---|---|---|
| Final EtE bandwidth estimate | 22 Mbps | 49 Mbps |
| NRT-allocation (model output) | 13 Mbps | 34 Mbps |

In one or more embodiments of the disclosure, example Table 7 depicts the application download from the play store with a specific bitrate, showing a usage speed, indicating saturating traffic of the available bandwidth, in accordance with an embodiment of the disclosure. The application (for example, telegram) may be downloaded from the Play Store with the specific bitrate, usage of 47 Mbps out of 50 Mbps shown in Table 8, indicating saturating of the available bandwidth. The current estimate may be more accurate. The RT bandwidth estimation may be utilized to optimize the allocation of resources, ensuring both RT and NRT traffic are effectively managed for enhanced performance.

TABLE 7

| | | | | | | Restriction | | |
|---|---|---|---|---|---|---|---|---|
| | | | Current EtE | Restriction | Historical | using | Final EtE | |
| | RT | NRT | bandwidth | using | EtE | Historical | bandwidth | |
| Time | bitrate | bitrate | estimate | Current EtE | estimate | EtE | estimate | isRestricted |
| 3 | 24 | 47 | 47 | 32 | 38 | 26 | 47 | 0 |
| 4 | 22 | 20 | 47 | 32 | 38 | 26 | 47 | 0 |
| 5 | 20 | 25 | 47 | 32 | 38 | 26 | 47 | 1 |
| 6 | 22 | 14 | 47 | 32 | 38 | 26 | 47 | 1 |
| 7 | 27 | 7 | 47 | 32 | 38 | 26 | 47 | 1 |
| 8 | 21 | 22 | 47 | 32 | 38 | 26 | 47 | 1 |
| 9 | 73 | 27 | 47 | 32 | 38 | 26 | 47 | 1 |
| 10 | 57 | 22 | 47 | 32 | 31 | 11 | 47 | 1 |
| 11 | 49 | 23 | 47 | 32 | 31 | 11 | 47 | 1 |
| 12 | 54 | 20 | 47 | 32 | 31 | 11 | 47 | 1 |
| 13 | 51 | 28 | 47 | 32 | 41 | 14 | 47 | 1 |
| 14 | 49 | 29 | 47 | 32 | 41 | | 47 | 1 |

TABLE 8

| | Without prior | With prior |
|---|---|---|
| Final EtE bandwidth estimate | 47 Mbps | 38 Mbps |
| NRT-allocation (model output) | 32 Mbps | 26 Mbps |

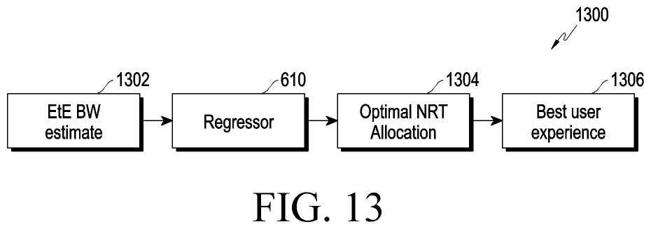

FIG. 13 illustrates a flow diagram 1300 of a regressor according to an embodiment of the disclosure.

Referring to FIG. 13, based on the various embodiments provided above, the formulation of the ML problem is made for the cases where no clear direct correlation of the RT traffic latency to any other measurable parameter can be established. Furthermore, the user experience of the user does not suffer much in excellent link conditions (>50 Mbps) even in the presence of NRT traffic. Hence the regressor 616 may be disabled in high-speed network conditions. At operation 1302, the regressor 616 may use the EtE bandwidth speed estimation. At operation 1304, the regressor 616 may determine the optimal NRT allocation required using the EtE bandwidth speed estimation. In an example, estimate the EtE bandwidth in a current network condition, the regressor 616 to decide the optimal value to be distributed. Finally, the traffic shaper 618 may be configured to restrict the NRT traffic to optimal value. At operation 1306, prioritize the RT traffic (for example, best user experience, video call experience). For example, on average in real-time applications like COD and PUBG, a 30% latency improvement may be observed.

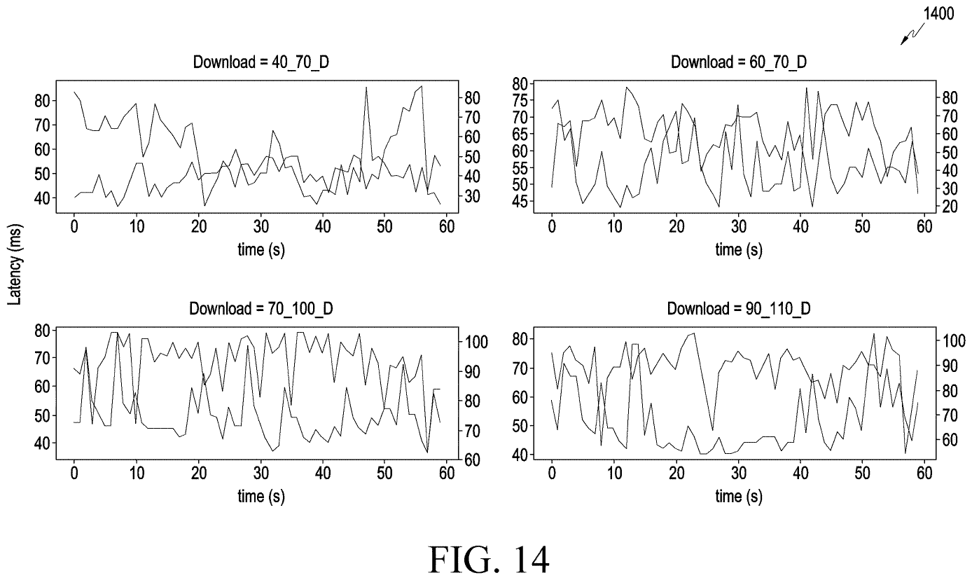

FIG. 14 illustrates a graphical representation of an effect on an application in various network conditions according to an embodiment of the disclosure.

Referring to FIG. 14, in an embodiment of the disclosure, different EtE bandwidths are tested for multiple network conditions like for 40-70 Mbps, 60-70 Mbps, 70-100 Mbps, and 90-110 Mbps, to evaluate the gaming QoE. From the graphical representation of FIG. 14, it can be seen that when the bandwidth is above 40 Mbps then the latency is not affected by the NRT traffic. However, certain real-time applications, slightly suffer in 40-50 Mbps conditions. Therefore, to avoid unnecessary NRT restriction for dynamic allocation algorithm may not be enabled, if the EtE bandwidth estimation is above 50 Mbps.

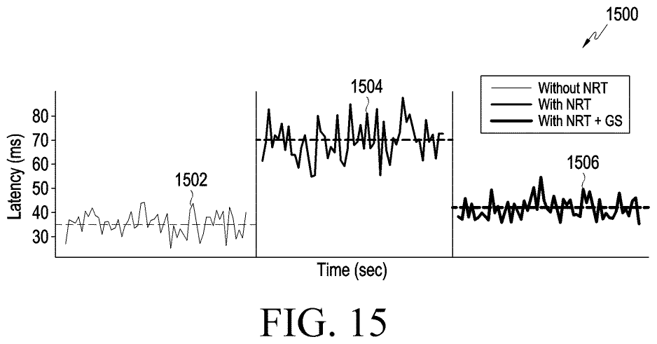

FIG. 15 illustrates a graphical representation of a latency according to an embodiment of the disclosure.

Referring to FIG. 15, a graphical representation 1500 may include three scenarios 1502, 1504, and 1506, such as the application without any NRT traffic, the application with the Play Store download (NRT Traffic), and the application with Play Store download and the regressor 616 enabled. In scenario 1502, where the application is running without any background NRT traffic, the latency remains low with minimal fluctuations, providing a smooth and stable user experience. Further, in scenario 1504, when the application is played alongside an active Play Store download (NRT traffic), the latency significantly increases and becomes highly unstable, resulting in a degraded user experience due to high fluctuations in network performance. Furthermore, in scenario 1506, With both the application and Play Store download running, enabling the regressor 616 brings the latency back to levels comparable to the scenario 1502, with minimal fluctuations. This ensures an improved and stable user experience, even in the presence of NRT traffic.

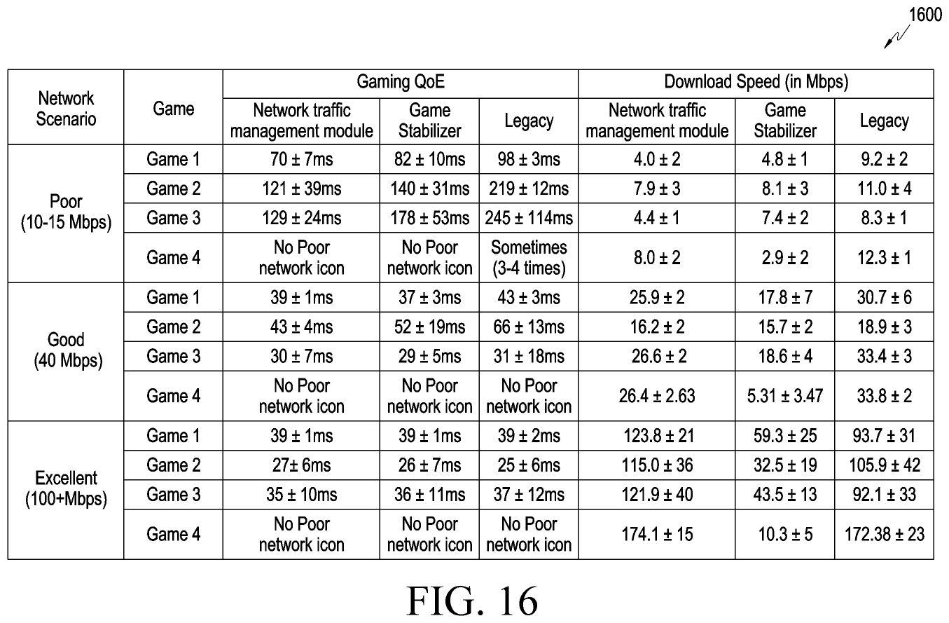

FIG. 16 illustrates a table depicting an evaluation of a network traffic management module according to an embodiment of the disclosure.

Referring to FIG. 16, a table 1600 may include the data on gaming QoE and download speed (in Mbps) for various applications across different network scenarios. For example, in poor network conditions (10-15 Mbps), the user experience and download speeds of the game stabilizer 610 and the legacy system may be affected. In moderate network quality conditions (40 Mbps), where the user experience and download speeds of the game stabilizer 610 and the legacy system may be generally improved compared to poor conditions, but not optimal. Excellent network conditions (100 plus Mbps), both the user experience and download speeds may be optimal, demonstrating the best performance and minimal latency. The network traffic management module 606 may be configured to provide a high-quality user experience and efficient download speeds across the described network conditions. Under the poor network conditions (10-15 Mbps), the network traffic management module 606 effectively manages traffic to improve the QoE. With the good network condition (40 Mbps), the network traffic management module 606 ensures a stable and enhanced user experience. In excellent network conditions (100 plus Mbps), the network traffic management module 606 maximizes both user experience and download speeds, leveraging the high bandwidth for superior results.

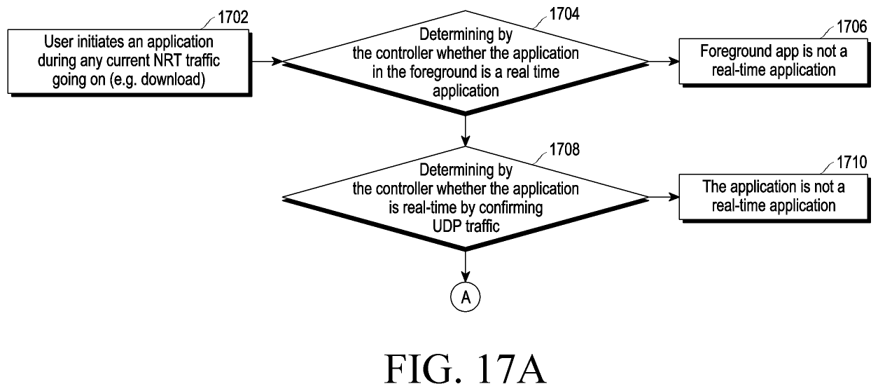

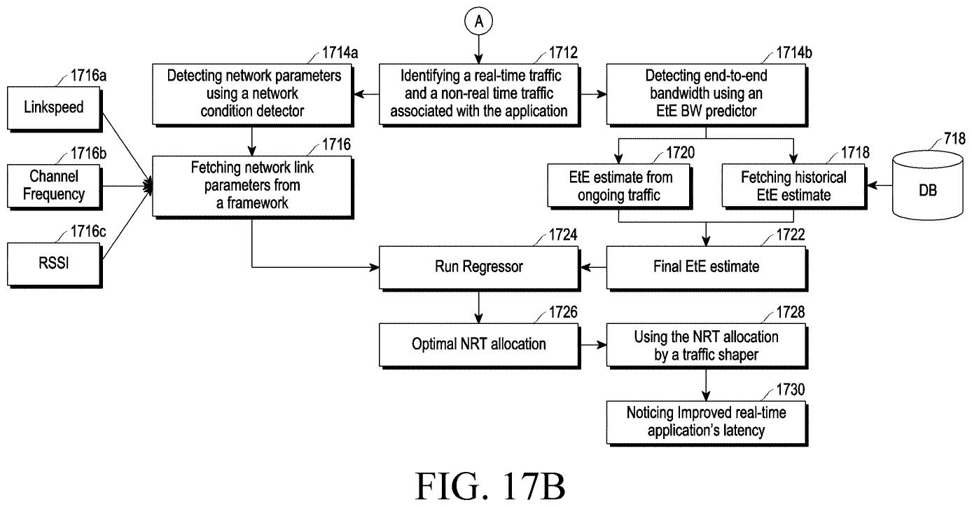

FIGS. 17A and 17B illustrate a sequence flow 1700 depicting a method for managing a traffic on a communication channel for a UE according to various embodiments of the disclosure.

Referring to FIGS. 17A and 17B, the communication channel may include various physical and logical layers that facilitate the transfer of data packets between the UE 602 and the network. The communication channel may include components and connections used to transfer data between the UE 602 and the network. The components and connections may include wireless connections like Wi-Fi, cellular networks (e.g., long term evolution (LTE), 5G), and any intermediary routers or switches.

Referring to FIGS. 17A and 17B, at operation 1702, the method 1700 may include initiating the application by the user during ongoing current NRT traffic (e.g., download).

At operation 1704, the method 1700 may include determining by the controller 608 whether the application in the foreground is a real-time application or not. At operation 1704, the method 1700 may include, If the controller 608 determines the application in the foreground is a non-real-time application, the method 1700 ends.

If the controller 608 determines the application in the foreground is the real-time application, at operation 1708, the method 1700 may include determining whether the application is real-time by confirming UDP traffic. If the controller 608 determines a non-real-time application, at operation 1710, the method 1700 may include that the application is not the real-time application.

If the controller 608 determines that the application is real-time application using real-time traffic, at operation 1712, the method 1700 may include identifying the real-time traffic and the non-real-time traffic associated with the application.

At operation 1714a, the method 1700 may include detecting the network parameters using the network condition detector 614. At operation 1714b, the method 1700 may include detecting EtE bandwidth using the EtE BW predictor.

At operation 1716, the method 1700 may include fetching information related to the network parameters (for example, the network link). The network parameters may include the wireless network throughput 1716a, the received signal strength 1716c, and the frequency of the channel 1716b.

At operation 1718, the method 1700 may include fetching the historical estimate of the network link (or channel) from the database 718. The database 718 may store the value of the average EtE for every link the UE 602 has previously connected. Here link may be differentiated based on the network parameters.

At operation 1720, the method 1700 may include using the current ongoing traffic, and measuring the maximum speed using the EtE BW predictor.

At operation 1722, the method 1700 may include predicting the EtE bandwidth using the historical estimate of the network link and the measured maximum speed.

At operation 1724, the method 1700 may include feeding the network parameters and the predicted EtE bandwidth to the regressor 616.

At operation 1726, the method 1700 may include providing an optimal NRT allocation by the regressor 616 for a current network scenario and the EtE bandwidth and passing the optimal NRT allocation onto the traffic shaper 618. As time progresses, the network parameters and the EtE bandwidth may change and hence the output of the regressor 616 may be updated accordingly.

At operation 1728, the method 1700 may include once the traffic shaper 618 receives the NRT allocation, using the NRT allocation by the traffic shaper 618. for example, the traffic shaper 618 may use a Linux traffic control and the eBPF to control the NRT traffic to a previously determined NRT allocation. The RT traffic may be allowed to flow unhindered.

At operation 1730, the method 1700 may include as a result, noticing lower and more stable real-time application's latency, leading to an overall improved user experience.

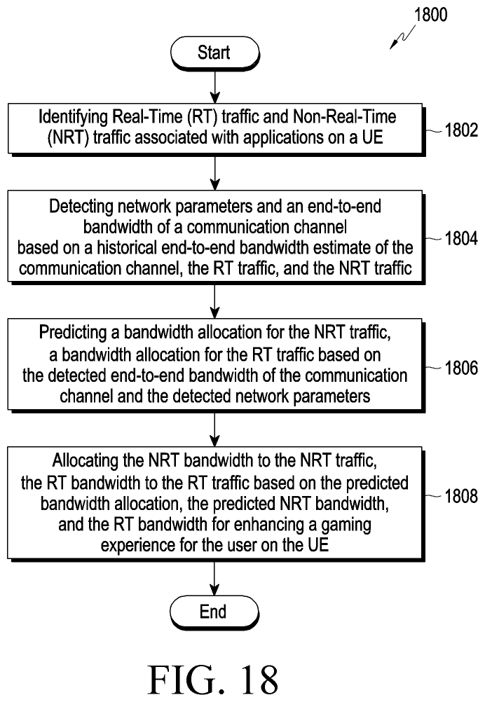

FIG. 18 illustrates a flowchart depicting a method for managing a traffic on a communication channel for a UE according to an embodiment of the disclosure.

Referring to FIG. 18, at operation 1802, a method 1800 may include identifying the RT traffic and the non-real-time traffic associated with the applications on the UE 602. In an embodiment of the disclosure, identifying the RT traffic may include receiving the predicted bandwidth allocation for the RT traffic.

At operation 1804, the method 1800 may include detecting the network parameters and the EtE bandwidth of the communication channel based on the historical EtE bandwidth estimate of the communication channel, the RT traffic, and the NRT traffic.

At operation 1806, the method 1800 may include predicting the bandwidth allocation for the NRT traffic, the bandwidth allocation for the RT traffic, based on the detected end-to-end bandwidth of the communication channel and the detected the network parameters.

At operation 1808, the method 1800 may include allocating the NRT bandwidth to the NRT traffic, the RT bandwidth to the RT traffic based on the predicted bandwidth allocation for enhancing the user experience for the user on the UE 602. In an embodiment of the disclosure, allocating the NRT bandwidth may include receiving the predicted bandwidth allocation for the NRT traffic.

In one or more embodiments of the disclosure, the method 1800 may include monitoring changes in the network parameters and the EtE bandwidth over a period of time. The method 1800 may include updating the NRT bandwidth based on the monitored changes in the one or more network parameters and the EtE bandwidth.

The method 1800 may include fetching the historical EtE bandwidth estimate of the channel from the database 718 associated with the UE 602. The database 718 may include the average value of the EtE bandwidth for the plurality of previously connected channels associated with the UE 602. The method 1800 may include regulating the NRT traffic based on the bandwidth allocation for the NRT traffic and the RT traffic. Further, the method 1800 may include enabling a flow of the RT traffic associated with the plurality of applications upon regulating the NRT traffic for enhancing the user experience for the user on the UE 602.

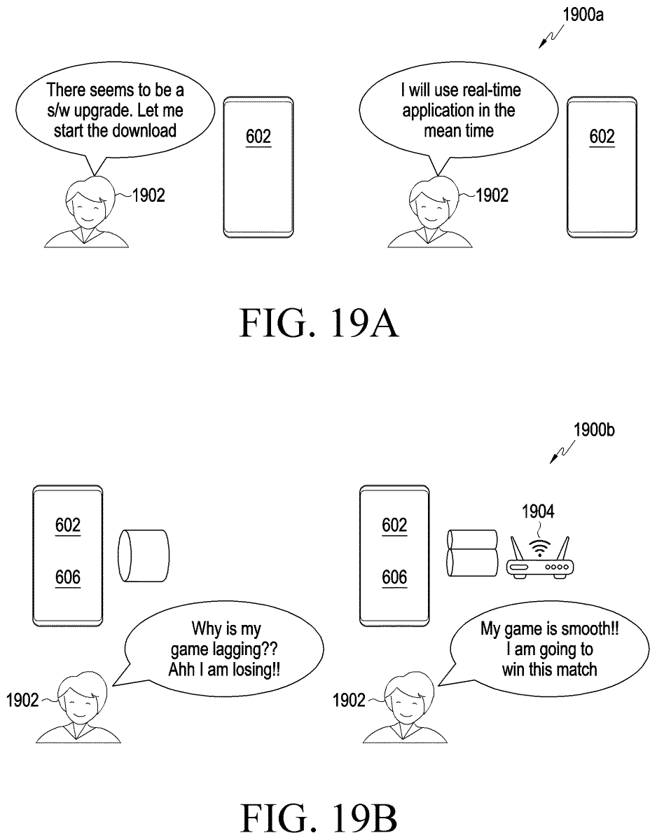

FIG. 19A illustrates a scenario depicting a UE without using a network traffic management module according to an embodiment of the disclosure.

Referring to FIG. 19A, in a scenario 1900a, the user 1902 who is actively using the real-time application PUBG on the UE initiates a download of the latest software update while connected to the network 1904. The download traffic may saturate the network link, consuming the available bandwidth. As the real-time application also requires bandwidth for real-time updates and data transmission, the RT traffic competes with the ongoing download. Given that RT traffic may typically include thin-streamed UDP packets, which are less robust in handling high bandwidth contention compared to other types of traffic, RT traffic struggles to secure sufficient resources against the saturated link. Consequently, this competition leads to increased latency for the real-time application, causing noticeable lag and occasional frame drops during the use of the real-time application. As a result, the user 1902 experiences a degraded user experience.

FIG. 19B illustrates a scenario depicting a UE using a network traffic management module according to an embodiment of the disclosure.

Referring to FIG. 19B, in a scenario 1900b, the network traffic management module 606 may be employed to manage bandwidth allocation efficiently. Upon initiating the real-time application while a software update is downloading, the network traffic management module 606 immediately begins collecting essential data, including the EtE bandwidth of the link and current network conditions. Utilizing the regressor 616, the system 604 determines the optimal bandwidth allocation for the ongoing download traffic, ensuring that it does not interfere with the user experience. The optimized allocation may create a dedicated, congestion-free bandwidth lane specifically for the real-time traffic. As a result, the real-time application operates with minimal latency, providing a smooth and responsive user experience. The user 1902 enjoys a low-latency environment, which significantly enhances the performance.

The system 604 ensures very low latency, even in the presence of non-real-time (NRT) traffic. The system 604 provides stable and consistent latency, minimizing fluctuations that are typically high without the network traffic management module 606. The system 604 significantly enhances the overall user experience.

In one or more embodiments of the disclosure, the NRT restriction may be maximized until transmit bad (TxBad) is minimized (close to zero). However, sometimes there is no increase in TxBadCount even when the real-time application latency increases due to the increased NRT allocation. Hence, this effort to increase background speed has proven to be bad for the real-time application. Further, in the case of decreasing EtE speed (like in the case of the device moving into poor signal condition) use a logic that tracks underutilization of NRT allocation and adjusts the EtE estimate. This logic gets activated when a high TxBadRate indicates a poor network. However, the TxBadRate may be high in few good conditions and hence this logic decreased NRT allocation unnecessarily. Furthermore, for adjusting EtE speed, in this case underutilization, is not required. However, TxBadCount may be high, falsely indicating a need for a decrease in estimated EtE speed as illustrated in below table 9. As can be seen from Table 9, RTT recovered without changing the NRT allocation.

TABLE 9

| time | appRx | bgRx | RestrictedBg | gammaPred | gammaActual | rxlinkspeed | txlinkspeed |
|---|---|---|---|---|---|---|---|
| 15 | 46 | 11 | 15 | 24 | 24 | 39 | 1 |
| 16 | 51 | 9 | 15 | 24 | 24 | 39 | 1 |
| 17 | 59 | 9 | 15 | 24 | 24 | 39 | 1 |
| 18 | 62 | 9 | 15 | 24 | 24 | 39 | 1 |
| 19 | 60 | 10 | 15 | 24 | 24 | 39 | 1 |
| 20 | 62 | 6 | 16 | 24 | 24 | 39 | 1 |
| 21 | 40 | 7 | 15 | 24 | 24 | 39 | 1 |
| 22 | 46 | 8 | 15 | 24 | 24 | 39 | 1 |
| 23 | 46 | 9 | 15 | 24 | 24 | 39 | 1 |
| 24 | 63 | 3 | 15 | 24 | 24 | 54 | 1 |
| 25 | 55 | 6 | 15 | 24 | 24 | 54 | 1 |
| 26 | 41 | 7 | 15 | 24 | 24 | 54 | 1 |
| 27 | 46 | 5 | 15 | 24 | 24 | 54 | 1 |
| 28 | 49 | 7 | 15 | 24 | 24 | 54 | 1 |
| 29 | 63 | 2 | 15 | 24 | 24 | 54 | 1 |
| 30 | 42 | 8 | 15 | 24 | 24 | 54 | 1 |
| 31 | 36 | 10 | 15 | 24 | 24 | 54 | 1 |
| 32 | 45 | 8 | 15 | 24 | 24 | 54 | 1 |

| Time | NetAPI | gbarcount | rulesapplied | isRecal | timestamp | TxBadCountRelative | RTT |
|---|---|---|---|---|---|---|---|
| 15 | 25 | 0 | 1 | 0 | 34:53.5 | 0 | 56 |
| 16 | 25 | 1 | 1 | 0 | 34:54.5 | 0 | 54 |
| 17 | 25 | 2 | 1 | 0 | 34:55.5 | 0 | 50 |
| 18 | 25 | 3 | 1 | 0 | 34:56.5 | 0 | 50 |
| 19 | 25 | 4 | 1 | 0 | 34:57.5 | 0 | 45 |
| 20 | 25 | 5 | 1 | 0 | 34:58.8 | 0 | 60 |
| 21 | 25 | 6 | 1 | 0 | 35:00.0 | 0.0472 | 50 |
| 22 | 25 | 7 | 1 | 0 | 35:01.0 | 0.0127 | 46 |
| 23 | 25 | 8 | 1 | 0 | 35:02.0 | 0 | 41 |
| 24 | 22 | 9 | 1 | 0 | 35:03.0 | 0.0303 | 80 |
| 25 | 22 | 10 | 1 | 0 | 35:04.1 | 0.0588 | 67 |
| 26 | 22 | 11 | 1 | 0 | 35:05.1 | 0.0178 | 64 |
| 27 | 22 | 12 | 1 | 0 | 35:06.1 | 0 | 52 |
| 28 | 22 | 13 | 1 | 0 | 35:07.1 | 0.0099 | 43 |
| 29 | 22 | 14 | 1 | 0 | 35:08.1 | 0.0078 | 45 |
| 30 | 22 | 15 | 1 | 0 | 35:09.1 | 0.0602 | 40 |
| 31 | 22 | 16 | 1 | 0 | 35:10.1 | 0 | 40 |
| 32 | 22 | 17 | 1 | 0 | 35:11.2 | 0 | 43 |

Although the network parameters may indicate a probability of a poor user experience, txBad does not always indicate a poor user experience. Hence, for achieving the QoE, the network MAC layer parameters may not be completely relied upon. Thus, the network parameters do not directly correlate with poor gaming performance.

The various actions, acts, blocks, steps, or the like in the flow diagrams may be performed in the order presented, in a different order, or simultaneously. Further, in some embodiments of the disclosure, some of the actions, acts, blocks, steps, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. In addition, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of an electronic device for managing traffic on a communication channel for a user equipment (UE), the method comprising:
identifying real-time (RT) traffic and non-real-time (NRT) traffic associated with a plurality of applications on the UE;
obtaining one or more network parameters and an end-to-end (EtE) bandwidth of the communication channel based on at least one of a historical EtE bandwidth estimate of the communication channel, the RT traffic, and the NRT traffic;
predicting a bandwidth allocation for the NRT traffic and a bandwidth allocation for the RT traffic based on the obtained EtE bandwidth of the communication channel and the obtained one or more network parameters; and
allocating an NRT bandwidth to the NRT traffic, and an RT bandwidth to the RT traffic based on the predicted bandwidth allocation for the NRT traffic and the predicted bandwidth allocation for the RT traffic.

2. The method of claim 1, further comprising:
monitoring changes in the one or more network parameters and the EtE bandwidth over a period of time; and
updating the NRT bandwidth based on the monitored changes in the one or more network parameters and the EtE bandwidth.

3. The method of claim 1, further comprising:
fetching the historical EtE bandwidth estimate of the communication channel from a database associated with the UE,
wherein the database comprises an average value of the EtE bandwidth for a plurality of previously connected communication channels associated with the UE.

4. The method of claim 1, wherein the one or more network parameters comprises one or more of a link speed, a received signal strength, and a frequency of the communication channel.

5. The method of claim 1, further comprising:
regulating the NRT traffic based on the bandwidth allocation corresponding to the NRT traffic and the RT traffic; and
enabling a flow of the RT traffic associated with the plurality of applications upon regulating the NRT traffic.

6. An electronic device for managing traffic on a communication channel for a user equipment (UE), the electronic device comprising:
memory, comprising one or more storage media, storing instructions; and
at least one processor communicatively coupled to the memory,
wherein the instructions, when executed by the at least one processor individually or collectively, cause the electronic device to:
identify real-time (RT) traffic and non-real time (NRT) traffic associated with a plurality applications on the UE,
obtain one or more network parameters and an end-to-end (EtE) bandwidth based on at least one of a historical EtE bandwidth estimate of the communication channel, the RT traffic, and the NRT traffic,
predict a bandwidth allocation for the NRT traffic and a bandwidth allocation for the RT traffic, based on the obtained EtE bandwidth of the communication channel and the obtained one or more network parameters, and
allocate an NRT bandwidth to the NRT traffic, and an RT bandwidth to the RT traffic based on the predicted bandwidth allocation for the NRT traffic and the predicted bandwidth allocation for the RT traffic.

7. The electronic device of claim 6, wherein the instructions, when executed by the at least one processor individually or collectively, further cause the electronic device to:
monitor changes in the one or more network parameters and the EtE bandwidth over a period of time, and
update the NRT bandwidth based on the monitored changes in the one or more network parameters and the EtE bandwidth.

8. The electronic device of claim 6,
wherein the instructions, when executed by the at least one processor individually or collectively, further cause the electronic device to fetch the historical EtE bandwidth estimate of the communication channel from a database associated with the UE, and
wherein the database comprises an average value of the EtE bandwidth for a plurality of previously connected communication channels associated with the UE.

9. The electronic device of claim 6, wherein the one or more network parameters comprises one or more of a link speed, a received signal strength, and frequency of the communication channel.

10. The electronic device of claim 6, wherein the instructions, when executed by the at least one processor individually or collectively, further cause the electronic device to:
regulate the NRT traffic based on the bandwidth allocation corresponding to the NRT traffic and the RT traffic, and
enable a flow of the RT traffic associated with a plurality of real-time applications upon regulating the NRT traffic.

11. One or more non-transitory computer readable storage media storing one or more computer programs including computer-executable instructions that, when executed by at least one processor of an electronic device individually or collectively, cause the electronic device to perform operations, the operations comprising:
identifying real-time (RT) traffic and non-real-time (NRT) traffic associated with a plurality of applications on a user equipment (UE);
obtaining one or more network parameters and an end-to-end (EtE) bandwidth of a communication channel based on at least one of a historical EtE bandwidth estimate of the communication channel, the RT traffic, and the NRT traffic;
predicting a bandwidth allocation for the NRT traffic and a bandwidth allocation for the RT traffic based on the obtained EtE bandwidth of the communication channel and the obtained one or more network parameters; and
allocating an NRT bandwidth to the NRT traffic, and an RT bandwidth to the RT traffic based on the predicted bandwidth allocation for the NRT traffic and the predicted bandwidth allocation for the RT traffic.

12. The one or more non-transitory computer readable storage media of claim 11, the operations further comprising:
monitoring changes in the one or more network parameters and the EtE bandwidth over a period of time; and
updating the NRT bandwidth based on the monitored changes in the one or more network parameters and the EtE bandwidth.

13. The one or more non-transitory computer readable storage media of claim 11, the operations further comprising:
fetching the historical EtE bandwidth estimate of the communication channel from a database associated with the UE,
wherein the database comprises an average value of the EtE bandwidth for a plurality of previously connected communication channels associated with the UE.

14. The one or more non-transitory computer readable storage media of claim 11, wherein the one or more network parameters comprises one or more of a link speed, a received signal strength, and a frequency of the communication channel.

15. The one or more non-transitory computer readable storage media of claim 11, the operations further comprising:
regulating the NRT traffic based on the bandwidth allocation corresponding to the NRT traffic and the RT traffic; and
enabling a flow of the RT traffic associated with the plurality of applications upon regulating the NRT traffic.

16. The one or more non-transitory computer readable storage media of claim 11, the operations further comprising:
adding max link speed as an upper limit when end-to-end speed estimation is greater than a wireless network throughput value.

17. The one or more non-transitory computer readable storage media of claim 13, wherein the database includes service set identifier (SSID) values, received signal strength indicator (RSSI) values, bandwidth values, and EtE bandwidth values.

18. The method of claim 1, further comprising:
adding max link speed as an upper limit when end-to-end speed estimation is greater than a wireless network throughput value.

19. The method of claim 3, wherein the database includes service set identifier (SSID) values, received signal strength indicator (RSSI) values, bandwidth values, and EtE bandwidth values.

20. The electronic device of claim 6, wherein the instructions, when executed by the at least one processor individually or collectively, further cause the electronic device to:
adding max link speed as an upper limit when end-to-end speed estimation is greater than a wireless network throughput value.
